(19) United States
(12) Patent Application Publication
(10) Pub. No.: US 2026/0368312 A1
(43) Pub. Date: Nov. 19, 2026

(54) SYSTEMS AND METHODS FOR ANOMALY DETECTION BASED ON COMPLIMENTARY SIDE-CHANNEL BEHAVIOR

(71) Applicants: BATTELLE ENERGY ALLIANCE, LLC, Idaho Falls, ID (US); University of Idaho, Moscow, ID (US)

(72) Inventors: Robert C. Ivans, Idaho Falls, ID (US); Craig Rieger, Pocatello, ID (US); Konstantinos Kolias, Moscow, ID (US)

(73) Assignees: BATTELLE ENERGY ALLIANCE, LLC, Idaho Falls, ID (US); University of Idaho, Moscow, ID (US)

(21) Appl. No.: 19/565,233

(22) Filed: Mar. 12, 2026

Related U.S. Application Data
(60) Provisional application No. 63/770,900, filed on Mar. 12, 2025.
(60) Provisional application No. 63/822,016, filed on Jun. 11, 2025.

(51) Int. Cl. G06F 21/55; G06N 3/0464

(52) U.S. Cl. CPC G06F 21/552; G06N 3/0464

(57) ABSTRACT

A machine-learned threat detector utilizes side-channel (SC) data captured from a computing device to detect anomalous operation and/or threats. The machine-learned threat detector may utilize SC data associated with a plurality of SC, such as a SC corresponding to electromagnetic radiation signals emitted by the computing device, thermodynamic characteristics of the computing device, power consumption, network communication, and/or the like. The machine-learned threat detector may be configured to integrate two or more SC sensors to assess threats. Independently trained networks may be configured for complimentary operation to improve threat detection performance.

### CROSS-REFERENCE TO RELATED APPLICATIONS

This application claims priority to U.S. Provisional Patent Application No. 63/770,900, entitled “Systems and Methods for Anomaly Detection,” filed Mar. 12, 2025, and U.S. Provisional Patent Application No. 63/822,016, entitled “Systems and Methods for Anomaly Detection,” filed Jun. 11, 2025, each of which is incorporated by reference herein.

### FEDERALLY SPONSORED RESEARCH AND DEVELOPMENT

This invention was made with government support under Contract Number DE-AC07-05-ID14517 awarded by the United States Department of Energy. The government has certain rights in the invention.

### TECHNICAL FIELD

This disclosure relates to systems and methods for anomaly detection and, more specifically, to systems and methods for anomaly detection based, at least in part, on the behavior of a plurality of side channels of a monitored system or device.

### BACKGROUND

Unless explicitly indicated otherwise, the approaches described in the technical field and background sections of this disclosure are not prior art to the claims in this disclosure nor admitted prior art.

As used herein, a side channel (SC) of a device refers to a mechanism by which information leakage can occur. A SC may be a side effect of device operation; an SC may relate to physical characteristics of the device during operation such as power consumption, electromagnetic radiation emission, or the like. For example, the execution of instructions by a processor of a device may result in current flow, which, in turn, may produce corresponding electromagnetic radiation signals.

The SC data produced by a computing device may be indicative of device behavior. For example, the response of one or more SC of a device may correspond to the instructions being executed by the device and/or operation of the device in a particular mode. Accordingly, side-channel data may be used to detect potential threats and/or anomalies, such as intrusion attempts, cyber-attack, or the like.

### Overview of Disclosure

This overview is provided to introduce a selection of concepts in a simplified form that are further described in greater detail below. This overview is not intended to identify key or essential inventive concepts of the claimed subject matter, nor is it intended for limiting the scope of the claimed subject matter. Some example embodiments, alternative embodiments, and selectively cumulative embodiments are set forth below:

Disclosed herein are examples of a system for detecting anomalies pertaining to a monitored device based, at least in part, on behavior exhibited by one or more side channels of the monitored device. Implementations of the disclosed system may comprise a processor and a SC security module configured for operation on the processor. The SC security module may comprise a first SC analysis module configured to generate first SC health metrics in response to first SC monitoring data configured to characterize behavior of a first SC of the monitored device, a second SC analysis module configured to generate second SC health metrics in response to second SC monitoring data configured to characterize behavior of a second SC of the monitored device, the second SC different to the first SC, and a combined assessment module configured to trigger detection of an anomaly pertaining to the monitored device based, at least in part, on the first SC health metrics generated from the first SC monitoring data and the second SC health metrics generated from the second SC monitoring data. The system may further include a mitigation module configured to implement a mitigation action pertaining to the monitored device in response to detection of the anomaly.

The system may further comprise a first SC data acquisition module configured to acquire the first SC monitoring data from an electromagnetic radiation (EM) SC of the monitored device such that the first SC monitoring data characterizes the behavior of the EM SC of the monitored device and a second SC data acquisition module configured to acquire the second SC monitoring data from one of a thermal (TH) SC of the monitored device such that the second SC monitoring data characterizes the behavior of the TH SC of the monitored device and a network (NW) SC of the monitored device such that the second SC monitoring data characterizes the behavior of the NW SC of the monitored device. The first SC health metrics may be configured to quantify a degree to which the behavior of the first SC characterized by the first SC monitoring data correspond to first SC signature data, the first SC signature data configured to characterize behavior of the first SC during nominal, non-anomalous operation of the monitored device. The second SC health metrics may be configured to quantify a degree to which the behavior of the second SC characterized by the second SC monitoring data correspond to second SC signature data, the second SC signature data configured to characterize behavior of the second SC during nominal, non-anomalous operation of the monitored device. The combined assessment module may be configured to trigger detection of an anomaly pertaining to the monitored device in response to one or more of (a) determining that a first deviation between the first SC monitoring data and the first SC signature data exceeds a first threshold, (b) determining that a second deviation between the second SC monitoring data and the second SC signature data exceeds a second threshold, and/or (c) determining that a combination of the first deviation and the second deviation exceeds a third threshold.

The first SC analysis module may be configured to generate the first SC health metrics based, at least in part, on a comparison between the first SC monitoring data and first SC signature data. The first SC signature data may be configured to characterize behavior of the first SC of the monitored device under one or more of (a) nominal, non-anomalous operating conditions of the monitored device, (b) anomalous operating conditions of the monitored device, and/or (c) anomalous operating conditions of the monitored device corresponding to a specified type of anomaly.

The first SC signature data may be configured to characterize the behavior of the first SC during execution of a specified software module on the monitored device. The SC security module may be further configured to retrieve the first SC signature data from a SC behavior profile selected from a plurality of SC behavior profiles maintained within a non-transitory storage medium. The SC security module may be configured to select the SC behavior profile based on one or more of a device type of the monitored device and the specified software module executing on the monitored device.

In some implementations, the first SC analysis module may comprise a first machine-learned (ML) SC behavior model configured to generate the first SC health metrics in response to the first SC monitoring data acquired from the first SC of the monitored device, the second SC analysis module may comprise a second ML SC behavior model configured to generate the second SC health metrics in response to the second SC monitoring data acquired from the second SC of the monitored device, and the combined assessment module may comprise a ML complimentary SC discriminator model configured to generate health metrics for the monitored device in response to the first SC health metrics generated by the first ML SC behavior model and the second SC health metrics generated by the second ML SC behavior model. The security module may be configured to trigger detection of an anomaly pertaining to the monitored device based, at least in part, on the health metrics generated by the ML complementary SC discriminator model.

The first SC may comprise an EM SC of the monitored device, and the first ML SC behavior model may comprise a first artificial neural network (ANN). The first ANN may comprise one or more convolutional layers configured to produce first output data in response to the first SC monitoring data, one or more fully connected layers configured to produce a second output data in response to the first output data produced by the one or more convolutional layers, and one or more dropout layers configured to produce third output data in response to the second output data generated by the one or more fully connected layers. The first SC health metrics may be based, at least in part, on the third output data produced by the one or more dropout layers.

The second SC may comprise a TH SC of the monitored device, and the second ML SC behavior model may comprise a second ANN. The second ANN may comprise one or more fully connected layers configured to produce output data in response to the second SC monitoring data and the second SC health metrics may be based, at least in part, on the output data produced by the one or more fully connected layers.

Disclosed herein are embodiments of a method and/or instructions stored on a non-transitory storage medium configured to cause a processor to perform a method for detecting anomalies pertaining to a monitored device based, at least in part, on behavior exhibited by one or more side channels of the monitored device. The method may comprise generating first SC health metrics in response to first SC monitoring data, the first SC monitoring data configured to characterize behavior of a first SC of the monitored device, generating second SC health metrics in response to second SC monitoring data, the second SC monitoring data configured to characterize behavior of a second SC of the monitored device different to the first SC, determining health metrics for the monitored device based, at least in part, on the first SC health metrics generated from the first SC monitoring data and the second SC health metrics generated from the second SC monitoring data, triggering detection of an anomaly pertaining to the monitored device based, at least in part, on the determined health metrics, and implementing a mitigation action pertaining to the monitored device in response to detection of the anomaly.

In some implementations, the method may further comprise acquiring the first SC monitoring data from an electromagnetic radiation (EM) SC of the monitored device such that the first SC monitoring data characterizes the behavior of the EM SC of the monitored device, and acquiring the second SC monitoring data from a thermal (TH) SC of the monitored device such that the second SC monitoring data characterizes the behavior of the TH SC of the monitored device. The first SC health metrics may be configured to quantify a degree to which the behavior of the first SC characterized by the first SC monitoring data correspond to first SC signature data, the first SC signature data configured to characterize behavior of the first SC during nominal, non-anomalous operation of the monitored device. The second SC health metrics may be configured to quantify a degree to which the behavior of the second SC characterized by the second SC monitoring data correspond to second SC signature data, the second SC signature data configured to characterize behavior of the second SC during nominal, non-anomalous operation of the monitored device. Detection of the anomaly pertaining to the monitored device may be triggered in response to one or more of (a) determining that a first deviation between the first SC monitoring data and the first SC signature data exceeds a first threshold, (b) determining that a second deviation between the second SC monitoring data and the second SC signature data exceeds a second threshold, and/or (c) determining that a combination of the first deviation and the second deviation exceeds a third threshold.

The first SC health metrics may be generated based, at least in part, on a comparison between the first SC monitoring data and first SC signature data, and wherein the first SC signature data are configured to characterize behavior of the first SC of the monitored device under one or more of (a) nominal, non-anomalous operating conditions of the monitored device, (b) anomalous operating conditions of the monitored device, and/or (c) anomalous operating conditions of the monitored device corresponding to a specified type of anomaly.

The first SC signature data may be configured to characterize the behavior of the first SC during execution of a specified software module on the monitored device, and the method may further comprise retrieving the first SC signature data from a SC behavior profile, the retrieving comprising selecting the SC behavior profile from a plurality of SC behavior profiles maintained within a non-transitory storage medium based on one or more of a device type of the monitored device and the specified software module executing on the monitored device.

In some implementations, the method further comprises configuring a first machine-learned (ML) SC behavior model to generate the first SC health metrics in response to the first SC monitoring data acquired from the first SC of the monitored device, configuring a second ML SC behavior model to generate the second SC health metrics in response to the second SC monitoring data acquired from the second SC of the monitored device, configuring a ML complimentary SC discriminator model to determine the health metrics for the monitored device in response to the first SC health metrics generated by the first ML SC behavior model and the second SC health metrics generated by the second ML SC behavior model, and triggering detection of the anomaly pertaining to the monitored device based, at least in part, on the health metrics determined by the ML complementary SC discriminator model.

The first SC may comprise an EM SC of the monitored device, and the first ML SC behavior model may comprise a first artificial neural network (ANN). The first ANN may comprise (a) one or more convolutional layers configured to produce first output data in response to the first SC monitoring data, (b) one or more fully connected layers configured to produce a second output data in response to the first output data produced by the one or more convolutional layers, and (c) one or more dropout layers configured to produce third output data in response to the second output data generated by the one or more fully connected layers. The first SC health metrics may be based, at least in part, on the third output data produced by the one or more dropout layers of the first ML SC behavior model.

The second SC may comprise a TH SC of the monitored device, and the second ML SC behavior model may comprise a second ANN. The second ANN may comprise one or more fully connected layers configured to produce output data in response to the second SC monitoring data, and the second SC health metrics may be based, at least in part, on the output data produced by the one or more fully connected layers of the second ML SC behavior model.

The ML complimentary SC discriminatory model may comprise a third ANN. The third ANN may comprise one or more fully connected layers configured to generate the health metrics for the monitored device in response to the first SC health metrics generated by the first ANN and the second SC health metrics generated by the second ANN.

Some implementations of the disclosed method further include (a) training the first ML SC behavior model to generate the first SC health metrics in response to the first SC monitoring data by use of a first SC training dataset comprising first SC data characteristic of known behaviors of the first SC of the monitored device, (b) training the second ML SC behavior model to generate the second SC health metrics in response to the second SC monitoring data by use of a second SC training dataset comprising second SC data characteristic of known behaviors of the second SC of the monitored device, and/or (c) training the complimentary SC discriminator model to generate health metrics for the monitored device in response to the first SC health metrics and the second SC health metrics generated by the first ML SC behavior model and the second ML SC behavior model in response to the first SC training dataset and the second SC training dataset.

### BRIEF DESCRIPTION OF DRAWINGS

Examples of systems, methods, devices, and computer-readable storage media comprising instructions configured to implement operations for EM-based threat detection are set forth in the accompanying figures and detailed description.

FIG. 1 is a schematic block diagram illustrating an example of an operating environment in which aspects of the systems and methods for threat detection may be practiced.

FIG. 2 is a schematic block diagram illustrating an example of a system configured to acquire side-channel data.

FIG. 3 is a schematic block diagram illustrating an example of a side-channel security module.

FIG. 4 is a schematic block diagram illustrating an example of a baseline side-channel assessment module.

FIGS. 5A-5I are schematic block diagrams illustrating examples of a datastore comprising information pertaining to monitored devices.

FIG. 6 is a schematic block diagram illustrating an example of a machine-learned threat and/or anomaly detection module.

FIG. 7A is a schematic block diagram illustrating an example of a system for training a machine-learned threat and/or anomaly detection system.

FIG. 7B is a schematic block diagram illustrating another example of a system for training a machine-learned threat and/or anomaly detection module.

FIG. 8 is a schematic block diagram illustrating another example of a machine-learned threat and/or anomaly detection module.

FIG. 9A is a schematic block diagram illustrating an example of a system for training a machine-learned threat and/or anomaly detection system.

FIG. 9B is a schematic block diagram illustrating another example of a system for training a machine-learned threat and/or anomaly detection system.

FIG. 10A is a schematic block diagram illustrating an example of a system configured to detect threats and/or anomalies pertaining to a monitored control system.

FIG. 10B illustrates an example of a graphical user interface for anomaly detection.

FIG. 10C is a schematic block diagram illustrating an example of a system configured to detect threats and/or anomalies pertaining to a plurality of different types of monitored devices.

FIG. 11A is a schematic block diagram illustrating an example of a system for detecting threats and/or anomalies based on the behavior of electromagnetic, thermodynamic, and/or power consumption characteristics of a monitored device.

FIG. 11B is a schematic block diagram illustrating an example of a system for detecting threats and/or anomalies based on the behavior of electromagnetic, thermodynamic, and/or network communication characteristics of a monitored device.

FIG. 12 is a schematic block diagram illustrating an example of a system for detecting threats and/or anomalies based on the behavior of electromagnetic and/or thermodynamic characteristics of a monitored device.

FIG. 13 is a schematic block diagram illustrating an example of a behavior model configured to characterize device operating conditions based on electromagnetic radiation emissions of a monitored device.

FIG. 14 is a schematic block diagram illustrating an example of a behavior model configured to characterize device operating conditions based on thermodynamic characteristics of a monitored device.

FIG. 15 is a schematic block diagram illustrating an example of a system for detecting threats and/or anomalies based on electromagnetic and thermodynamic characteristics of a monitored device.

FIG. 16 is a flow diagram illustrating an example of a method for detecting anomalies pertaining to a monitored device based on the behavior of a plurality of side channels.

FIG. 17 is a flow diagram illustrating an example of a method for developing side channel behavior models.

FIG. 18 is a flow diagram illustrating another example of a method for detecting anomalies pertaining to a monitored device based on the behavior of a plurality of side channels.

### DETAILED DESCRIPTION

### Preliminary Notes

Example embodiments are described below with reference to the accompanying drawings briefly introduced above. Unless otherwise expressly stated, the sizes, positions, etc., of components, features, elements, etc., as well as any distances therebetween, are not necessarily to scale, and may be disproportionate and/or exaggerated for clarity.

The embodiments described herein are merely examples, set forth by way of illustration only and not limitation. Those skilled in the art will recognize in light of the teachings herein that there are alternatives, variations and equivalents to the example embodiments described herein and their component parts. For example, other embodiments are readily possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” “comprising,” “include,” “includes,” “including,” “has,” “have,” and “having,” when used in this document, are open-ended and specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another and not to imply any relative order, placement, or ranking. For example, one element could be termed a “first element” and similarly, another element could be termed a “second element,” or vice versa. The same is true of labels like (a), (b), (c) or (1), (2), (3), etc. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the drawings. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all functional or operative connections may be direct or indirect. Similarly, unless clearly indicated otherwise, all physical connections may be rigid or non-rigid, permanent or temporary, direct or indirect (e.g., via intermediary components).

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings. Additionally, the drawings may include non-essential elements that are included only for the sake of thoroughness. These non-essential elements may be removed entirely or left only in outline form if drawing changes are desired to create greater clarity.

Not every feature shown in every drawing is labeled with a reference number, even though the same feature may be labeled with a reference number on other drawings. Reference numbers have been omitted where it is believed they would unnecessarily clutter a drawing. However, all rights are reserved to add reference numbers to the drawings to clarify aspects of the embodiments. Moreover, some views omit some features shown in other views. Finally, the drawings sometimes illustrate variations from one drawing to another, even where those drawings are intended to depict the same embodiment.

### EXAMPLE EMBODIMENTS

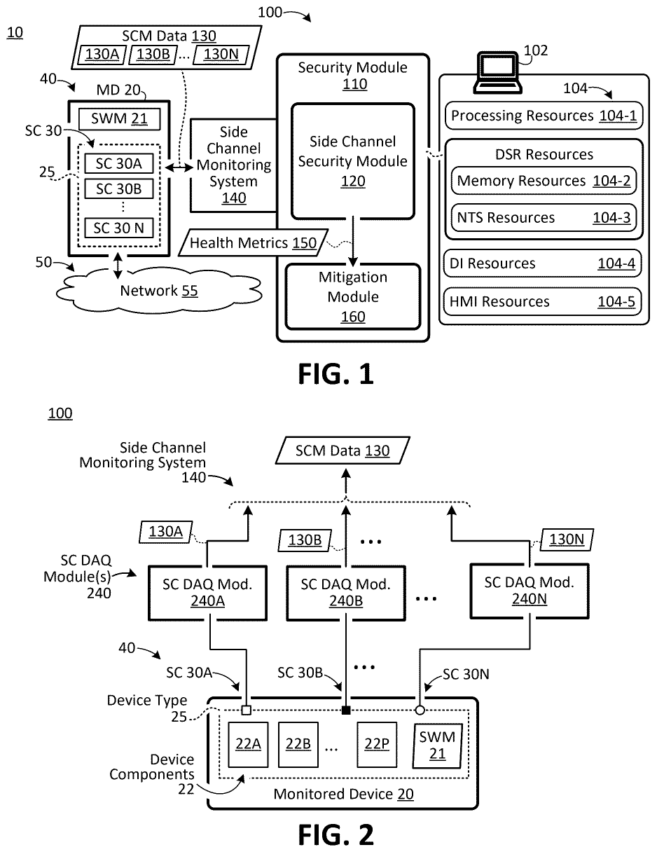

FIG. 1 illustrates an example of an operating environment 10 in which aspects of the system and methods for threat and/or anomaly detection disclosed herein may be practiced. The operating environment 10 may comprise a threat and/or anomaly detection system 100. The system 100 may comprise and/or be coupled to an apparatus 102, which may be configured to implement aspects of SC-based threat and/or anomaly detection, as disclosed herein. The apparatus 102 may comprise and/or be embodied by one or more physical components, which may include, but are not limited to: an electronic device, a computing device, a general-purpose computing device, an application-specific computing device, a mobile computing device, a smart phone, a tablet, a laptop, a server device, a distributed computing system, a cloud-based computing system, an embedded computing system, and/or the like.

The apparatus 102 may comprise and/or be coupled to computing resources 104. The computing resources 104 may comprise any suitable computing means including, but not limited to processing resources 104-1, data storage and/or retrieval (DSR) resources (e.g., memory resources 104-2, non-transitory storage (NTS) resources 104-3, and/or the like), data interface (DI) resources 104-4, human-machine interface (HMI) resources 104-5, and/or the like.

The processing resources 104-1 may comprise any suitable processing means including, but not limited to: processing circuitry, logic circuitry, an integrated circuit (IC), a processor, a physical processor, a virtual processor (e.g., a virtual machine), an arithmetic-logic unit (ALU), a central processing unit (CPU), a general-purpose processor, a programmable logic device (PLD), a field programmable gate array (FPGA), an application-specific integrated circuit (ASIC), a System on Chip (SoC), virtual processing resources, and/or the like.

The DSR resources may comprise any suitable means for storing, retrieving, maintaining, and/or otherwise managing data which may include, but are not limited to memory resources 104-2, NTS resources 104-3, and/or the like. The memory resources 104-2 may comprise any suitable memory means including, but not limited to: volatile memory, non-volatile memory, random access memory (RAM), dynamic RAM (DRAM), synchronous DRAM (SDRAM), cache memory, or the like. The NTS resources 104-3 may comprise any suitable non-transitory, persistent, and/or non-volatile storage means including, but not limited to: a non-transitory storage device, a persistent storage device, an internal storage device, an external storage device, a remote storage device, Network Attached Storage (NAS) resources, a magnetic disk drive, a hard disk drive (HDD), a solid-state storage device (SSD), a Flash memory device, and/or the like.

The DI resources 104-4 may comprise any suitable data communication and/or interface means including, but not limited to: a communication interface, an I/O interface, a device interface, a network interface, an interconnect, and/or the like. In some implementations, the data interface 104-4 may be configured to communicatively couple the apparatus 102 to a network, which may include, but is not limited to: an electronic communication network, a computer network, a wired network, a wireless network, a local area network (LAN), a wide area network (WAN), a virtual private network (VPN), Internet Protocol (IP) networks, Transmission Control Protocol/Internet Protocol (TCP/IP) networks, the Internet, or the like.

The HMI resources 104-5 may comprise any suitable means for human-machine interaction including, but not limited to: input devices, output devices, input/output (I/O) devices, visual output devices, display devices, monitors, touch screens, a keyboard, gesture input devices, a mouse, a haptic feedback device, an audio output device, a neural interface device, and/or the like.

The apparatus 102 may comprise a security module 110. Aspects of the security module 110 (and/or components thereof) may be implemented and/or embodied by computing resources 104 of the apparatus 102. For example, aspects of the security module 110 may be configured for operation on processing resources 104-1 of the apparatus 102, utilize data storage and/or retrieval resources of the apparatus 102 (e.g., memory resources 104-2, NTS resources 104-3, and/or the like), may be implemented and/or embodied by MEI stored within NTS resources 104-3 of the apparatus 102, and so on.

The security module 110 may be configured to implement one or more threat and/or anomaly detection (TAD) functions. The TAD functions may comprise detecting threats and/or anomalies pertaining to a monitored device 20 and/or MS 40. As used herein, a monitored device (MD) 20 may comprise and/or refer to any suitable type of device or component including, but not limited to: an electronic device, an intelligent electronic device (IED), a computer, a computing device, a compute node, a control device, a control module, a controller, programmable logic, a programmable logic controller (PLC), a System on Chip (SoC), a physical device (e.g., sensor, actuator, or the like), an I/O device, a communication device, a control system device, a sensor, an actuator, a measurement device, a monitoring device, a communication device, and/or the like.

In some implementations, the security module 110 may be configured to detect threats and/or anomalies pertaining to an monitored system 40. For example, the security module 110 may be configured to implement TAD functions pertaining to one or more MD 20 of a monitored system 40. As used herein, a monitored system (MS) 40 may comprise and/or refer to any suitable collection of interconnected components; an MS 40 may include, but is not limited to a: computing system, a high-performance computing system, a distributed computing system, a grid computing system, a data storage and retrieval system, an industrial control system, an intelligent control system, a distributed control system, an of the embedded control system, a vehicle control system, a building control system, a process control system, a plant control system, a manufacturing control system, a power control system, a power generation system, a power plant, a power distribution system, a power grid system, a Supervisory Control and Data Acquisition (SCADA) system, and/or the like. In some implementations, the MS 40 may comprise and/or be referred to as a cyber-physical system (e.g., the MS 40 may comprise tightly coupled cyber communication, computation, and physical substrates) and the MD 20 may comprise a component of the cyber-physical system such as a control component (e.g., a control device, control node, control module, and/or the like), a compute component (e.g., a computing device, a compute node, a compute module, and/or the like), a cyber component (e.g., a cyber communication component such as a network device, network node, network module, and/or the like), a physical component (e.g., a sensor, actuator, and/or the like), an I/O component (e.g., a device configured to communicatively and/or operatively connect one or more physical components to cyber infrastructure such as an electronic communication network), and/or the like.

In some implementations, the MD 20 may be coupled to communication infrastructure 50 of the MS 40 such as a network 55 or the like. The network 55 may comprise any suitable communication means including, but not limited to: an electronic communication network, an internal network, an Internet Protocol (IP) network, a wireless network, a Local Area Network (LAN), a Wide Area Network (WAN), a Virtual Private Network (VPN), a wireless network (e.g., IEEE 802.11a-n wireless network, Bluetooth® network, Near-Field Communication (NFC) network, and/or the like), a public switched telephone network (PSTN), a mobile network (e.g., a network configured to implement one or more technical standards or communication methods for mobile data communication, such as Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), High Speed Uplink Packet Access (HSUPA), Long Term Evolution (LTE), LTE-A (Long Term Evolution-Advanced), and/or the like), an embedded network, a control network, a process control network, a sensor network, an actuator network, a SCADA network, a Distributed Network Protocol (DNP3) network, an International Electrotechnical Commission 60870 (IEC 60870) network, an Experimental Physics and Industrial Control System (EPICS), a combination of networks, a Phasor network, a plurality of networks, a plurality of separate networks, a plurality of communicatively and/or operatively coupled networks, and/or the like.

As illustrated in FIG. 1, the security module 110 may comprise and/or be coupled to an SC security (SCS) module 120. The SCS module 120 may be configured to detect potential threats and/or anomalies based, at least in part, on the behavior of one or more side channels (SC) 30 of the MD 20. In other words, the SCS module 120 may be configured to implement a TAD function that incorporates, inter alia, information pertaining to the behavior of the one or more SC 30. The SCS module 120 may be configured to a) monitor one or more SC 30 of the MD 20 and b) detect potential threats and/or anomalies pertaining to the MD 20 based, at least in part, on the monitoring. The monitoring may comprise acquiring SC monitoring data 130 pertaining to one or more SC 30. As used herein, SC monitoring (SCM) data 130 may comprise and/or refer to information pertaining to the behavior of one or more SC 30 of a MD 20. The SCS module 120 may be configured to detect threats and/or anomalies based, at least in part, on the behavior of any suitable SC 30 including, but not limited to, SC 30 pertaining to one or more of: electromagnetic radiation (EM) emission; thermodynamic (TH) characteristics; electrical characteristics (e.g., power consumption), acoustics; mechanical (MEC) characteristics of the MD 20 such as vibrations or the like; memory access characteristics; the timing of tasks performed by the MD 20; characteristics of network communication pertaining to the MD 20; and/or the like. In some implementations, the SCS module 120 may be configured to monitor a plurality of different SC 30 of the MD 20. As illustrated in the FIG. 1 example, the SCS module 120 may be configured to monitor N SC 30 of the MD 20, e.g., may be configured to detect threats and/or anomalies pertaining to the MD 20 based on, inter alia, the behavior of one or more of SC 30A-N.

The SCS module 120 may be configured to acquire SCM data 130 by any suitable means and/or from any suitable source. As illustrated in the FIG. 1 example, the SCS module 120 may be configured to acquire SCM data 130 from the MD 20 by use of an SC monitoring (SCM) system 140. The SCM system 140 may be configured to acquire SCM data 130 pertaining to any suitable SC 30, as disclosed herein. The SCM system 140 may be configured to acquire SCM data 130 by any suitable means, including, but not limited to one or more: sensors, detectors, monitors, antenna, instruments, probes, feelers, receivers, measurement devices, data acquisition modules, and/or the like.

In some implementations, the SCM system 140 may be configured to capture SCM data 130 pertaining to a plurality of different SC 30 of a MD 20 (and/or different types of SC 30). In the example illustrated in FIG. 1, the SCM system 140 may be configured to monitor N different SC 30 of the MD 20, e.g., the SCM module 130 may be configured to acquire SCM data 130A-N pertaining to SC 30A-30N of the MD 20, respectively.

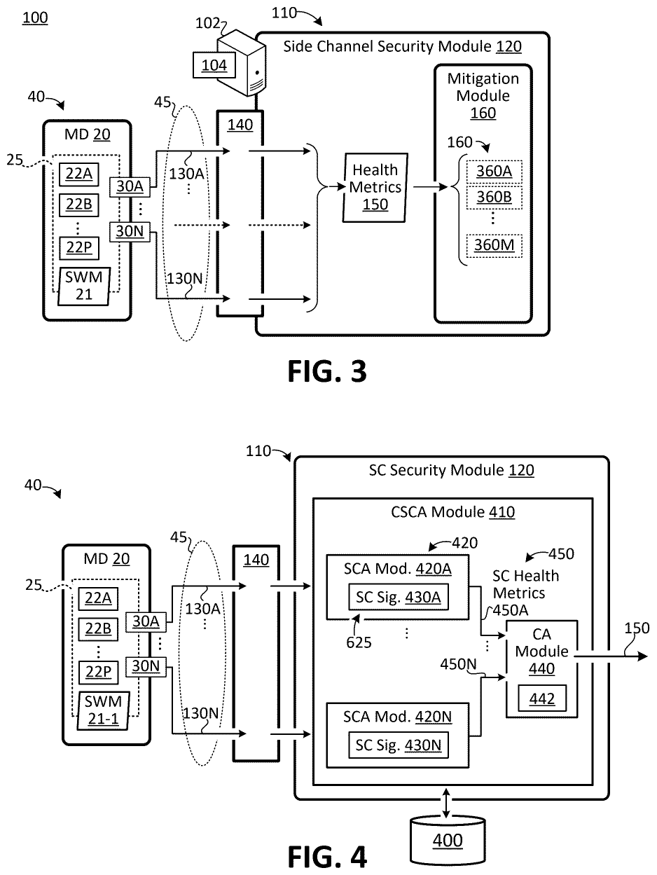

FIG. 2 is a schematic block diagram illustrating an example of an SCM system 140 configured to, inter alia, monitor SC 30 of a MD 20. As illustrated in the FIG. 2 example, the SCM system 140 may comprise and/or be coupled to one or more SC data acquisition modules 240, each configured to monitor one or more SC 30 of the MD 20. As used herein, an SC data acquisition (DAQ) module 240 may comprise and/or refer to any suitable means for sensing, detecting, measuring, capturing, gathering, observing, monitoring, and/or otherwise acquiring SCM data 130 pertaining to a SC 30. In the FIG. 2 example, the SCM system 140 comprises N SC DAQ modules 240 configured to monitor N SC 30 of the MD 20. In other words, the SC DAQ modules 240A-N may be configured to monitor SC 30A-N, respectively (e.g., acquire SCM data 130A-N pertaining to SC 30A-N).

As illustrated in FIG. 2, the MD 20 may be associated with a device type 25. As used herein, a device type 25 may comprise and/or refer to a specification that defines the logical and/or physical functionality, structure, and/or implementation of a device. For example, the device type 25 of a MD 20 may define the design and implementation of components comprising the MD 20 (device components (DC) 22), the architecture of the MD 20 (e.g., configuration and/or arrangement of the DC 22 comprising the MD 20), interconnections between DC 22 of the MD 20, and so on. For example, the device type 25 may specify the design and/or implementation of the MD 20, including DC 22A-P comprising the MD 20. In other words, a device type 25 may define the architecture or class of MD 20.

In some implementations, the MD 20 may comprise and/or be configured to operate in accordance with software, e.g., a software module 21. As used herein, a software module (SWM) 21 may comprise and/or refer to any suitable means for controlling the operation of a MD 20. A SWM 21 may include, but is not limited to firmware, configuration data, settings data, a binary, an executable, an application, a program, a library, a package, an operating system, and/or the like. For example, a SWM 21 may comprise machine-readable instructions configured for execution by processing resources of the MD 20. The SWM 21 implemented by a MD 20 may control the manner in which the MD 20 operates and, as such, may impact the SC behavior of the MD 20.

As disclosed herein, the SC DAQ modules 240 of the SCM system 140 may be configured to acquire SCM data 130 pertaining to respective SC 30. In some implementations, one or more of the SC DAQ modules 240A-N may be configured to monitor SC 30 corresponding to specified DC 22 of the MD 20. By way of non-limiting example, the SC 30A monitored by the SC DAQ module 240A may correspond to EM emissions produced by a first DC 22A of the MD 20 such as a processor, logic chip, or the like; the SC 30B monitored by the SC DAQ module 240B may correspond to thermodynamic characteristics of a second DC 22B of the MD 20; and so on. Although FIG. 2A describes specific examples of SC 30, the disclosure is not limited in this regard and could be adapted to monitor any suitable SC 30 and/or combination thereof. For example, multiple SC DAQ modules 240 may be configured to monitor SC 30 corresponding to the same DC 22. By way of non-limiting example, the SC DAQ module 240A may be capable of monitoring an EM SC 30 of DC 22A (e.g., SC 30A) and the SC DAQ module 240B may be capable of monitoring a TH SC 30 of DC 22A (e.g., SC 30B). The DC 22A may comprise any suitable DC 22 of the MD 20 such as a processor, CPU, SoC, or the like.

The SCM data 130 acquired by the SC DAQ modules 240 may be communicated to one or more endpoints. In some implementations, the SCM data 130 may be recorded within non-transitory storage, such as a datastore or the like (e.g., may be maintained within a datastore 400, as disclosed in further detail herein). Alternatively, or in addition, the SCM system 140 may be configured to provide SCM data 130 to the SCS module 120. In some implementations, the SCM data 130 acquired by one or more of the SC DAQ modules 240A-N may be communicated via an electronic communication network, such as the network 55 illustrated in FIG. 1. Alternatively, or in addition, one or more of the SC DAQ modules 240A-N may be communicatively and/or operatively coupled to the SCS module 120 through separate network(s), dedicated connection(s), and/or the like. SCM data 130 may be communicated by using any suitable protocol or scheme. For example, one or more of the SC DAQ modules 240A-N may be configured to push SCM data 130A-N to the SCS module 120, e.g., one or more of the SC DAQ modules 240A-N may be configured to transmit, send, broadcast, and/or otherwise provide SCM data 130 to the SCS module 120. Alternatively, or in addition, the SCS module 120 may be configured to pull SCM data 130 from one or more of the SC DAQ modules 240A-N, e.g., the SCS module 120 may be configured to request, demand, query, and/or otherwise retrieve SCM data 130 from one or more of the SCM DAQ modules 240A-N.

Referring back to FIG. 1, the SCS module 120 may be configured to detect threats and/or anomalies pertaining to the MD 20 based, at least in part, on the behavior of SC 30 of the MD 20, e.g., based on SCM data 130 acquired by the SCM system 140. In some implementations, the SCS module 120 may be configured to generate health metrics 150 for the MD 20. As used herein, health metrics 150 may comprise and/or refer to any suitable means for indicating the health of an MD 20 and/or MS 40. The health metrics 150 may comprise quantitative data, qualitative data, a combination of quantitative and qualitative data, and/or the like. For example, the health metrics 150 may comprise quantitative data such as a health score, which may be configured to indicate a degree to which the behavior(s) exhibited by one or more SC 30 of the MD 20 and/or MS 40 are indicative of nominal, non-anomalous operation. Alternatively, or in addition, the health metrics 150 may comprise qualitative data such as one or more labels, which may be configured to classify the behavior(s) exhibited by the one or more SC 30, e.g., labels classifying the SC behavior as “nominal,” “anomalous,” or the like.

As disclosed above, in some implementations, the SCS module 120 may be configured to generate health metrics 150 comprising quantitative data. The SCS module 120 may be configured to generate health metrics 150 comprising any suitable type of quantitative data including, but not limited to: (a) a health score quantifying a degree to which the behavior(s) exhibited by the SC 30 of the MD 20 (and/or MS 40) are indicative of nominal, non-anomalous operation, e.g., a value between 1 and 0, where 1 is indicative of nominal, non-anomalous operation and 0 indicates anomalous operation; (b) an anomaly score, e.g., a value between 1 and 0, where 1 is indicative of anomalous operation and 0 indicates a nominal, non-anomalous operation; (c) a plurality of anomaly scores, each anomaly score indicating a degree to which the behavior(s) exhibited by SC 30 of the MD 20 (and/or MS 40) are indicative of a specified type of anomaly such as a specified threat, attack, compromise, fault, failure, or the like; and/or other suitable type(s) of quantitative data.

Alternatively, or in addition, the SCS module 120 may be configured to generate health metrics 150 comprising qualitative data, such as semantic label(s) or the like. For example, the health metrics 150 may comprise semantic label(s) classifying the behavior exhibited by the one or more SC 30 of the MD 20 and/or MS 40. The health metrics 150 may comprise any suitable type of qualitative data including, but not limited to: (a) labels configured to indicate that the behavior(s) exhibited by the one or more SC 30 of the MD 20 are indicative of “healthy,” “nominal,” or “non-anomalous” operation of the MD 20; (b) labels configured to indicate a degree to which the behavior(s) exhibited by the one or more SC 30 of the MD 20 are indicative of “healthy,” “nominal,” or “non-anomalous” operation of the MD 20; (c) labels configured to indicate that the behavior(s) exhibited by the one or more SC 30 of the MD 20 are indicative of “anomalous” operation of the MD 20; (d) labels configured to indicate a degree to which the behavior(s) exhibited by the one or more SC 30 of the MD 20 are indicative of “anomalous” operation of the MD 20; (e) labels configured to indicate that the behavior(s) exhibited by the one or more SC 30 of the MD 20 are indicative of a specified type of anomaly, e.g., a specified type of threat, attack, compromise, fault, failure, or the like; (f) labels configured to indicate a degree to which the behavior(s) exhibited by the one or more SC 30 of the MD 20 are indicative of respective anomaly types; and/or the like.

Although examples of specific types of health metrics 150 are disclosed herein, the disclosure is not limited in this regard and could be adapted to generate and/or interpret health metrics 150 comprising any suitable type of health-related information in any suitable format. As disclosed herein, the health metrics 150 may comprise quantitative data (e.g., health scores, anomaly scores, and/or the like), qualitative data (e.g., semantic labels), a combination of quantitative data and qualitative data (e.g., health and/or anomaly scores along with corresponding semantic labels), and so on.

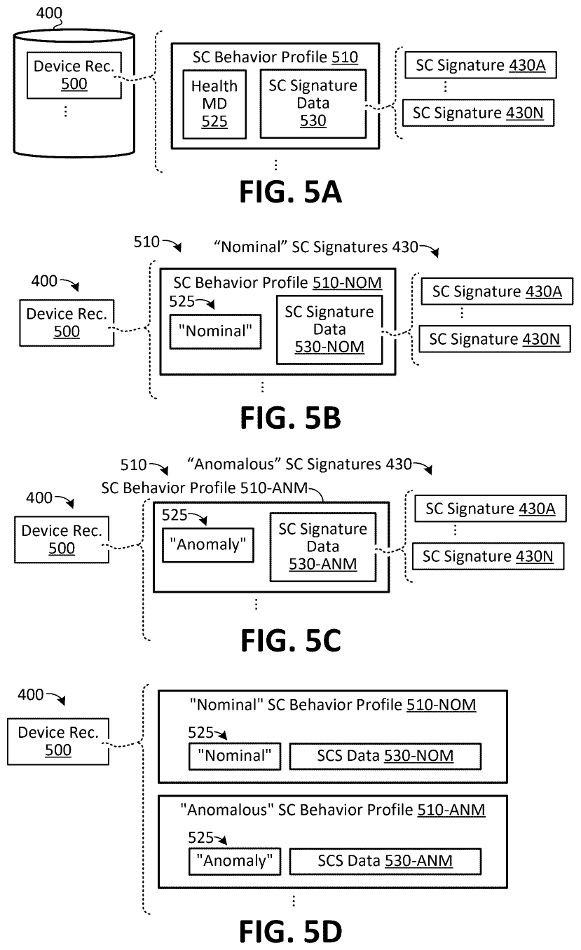

In some implementations, the security module 110 may further comprise and/or be coupled to a mitigation module 160. As illustrated in FIG. 3, the mitigation module 160 may be configured to implement one or more mitigation actions 360 pertaining to the MD 20 and/or MS 40 based, at least in part, on the health metrics 150 determined by the security module 110. The mitigation module 160 may be configured to implement any suitable mitigation action(s) 360 including, but not limited to: notifying one or more external entities of the detected threat or anomaly, such as a user, administrator, security system, intrusion detection system, or the like (e.g., sending electronic message(s), email, text message(s), and/or the like), configuring the MD 20 to operate in a specified mode (e.g., configure the MD 20 to operate in a “safe” mode), resetting the MD 20 (e.g., resetting the SWM 21 implemented by the MD 20), disabling the MD 20, reconfiguring the MS 40 (e.g., replacing the MD 20 with other components of the MS 40), and/or the like. The mitigation module 160 may be configured to implement any number of mitigation actions 360 in response to health metrics 150 indicating detection of threats and/or anomalies. In the FIG. 3 example, the mitigation module 160 may be configured to implement M mitigation actions 360A-M in response to detecting a threat and/or anomaly pertaining to the MD 20.

The SCS module 120 may be configured to generate health metrics 150 based on the behavior of one or more SC 30 of the MD 20. In the FIG. 3 example, the SCS module 120 may be configured to, inter alia, generate health metrics 150 based on the behavior of SC 30A-N of the MD 20, e.g., as indicated by SCM data 130A-N acquired by the SCM system 140. The SCS module 120 may be configured to derive health metrics 150 from SCM data 130 by any suitable means, as disclosed in further detail herein.

By way of non-limiting example, the SCS module 120 may be configured to detect threats and/or anomalies by comparing the SC behavior of the MD 20 to known SC behaviors, e.g., SC behavior characteristic of nominal, non-anomalous operating conditions. The SC behavior exhibited by an MD 20 may be characteristic of the operating conditions of the MD 20. In other words, the behavior one or more SC 30 during nominal, non-anomalous operating conditions may be distinguishable from behavior exhibited during “anomalous” operating conditions (e.g., during a threat, attack, compromise, failure, and/or the like). In other words, the behavior of one or more SC 30A-N may be indicative of the operating conditions of the MD 20 (e.g., may be indicative of whether the MD 20 is under threat, attack, compromise, and/or other anomalous operating conditions). Accordingly, the SCS module 120 may be configured to trigger detection of a threat and/or anomaly when the behavior of one or more SC 30A-N of the MD 20 deviates from “nominal” SC behavior.

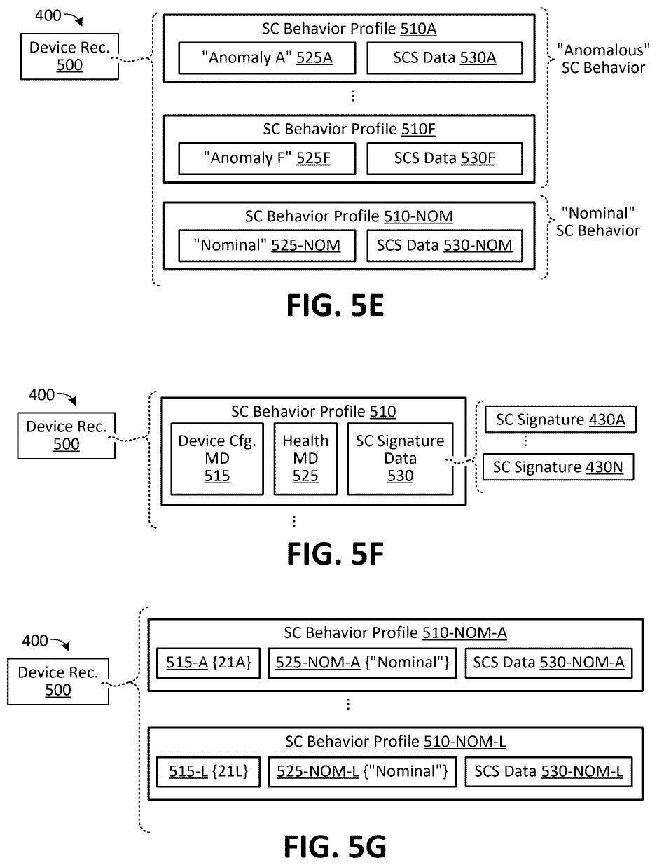

FIG. 4 is a schematic block diagram illustrating an example of an SCS module 120 configured to, inter alia, detect threats and/or anomalies based, at least in part, on baseline SC behavior. In the FIG. 4 example, the SCS module 120 may be configured to detect threats and/or anomalies by, inter alia, comparing the behavior exhibited by SC 30 of the MD 20 to SC signatures 430 characteristic of specified operating conditions, e.g., SC behavior characteristic of nominal, non-anomalous operating conditions. As used herein, an SC signature 430 may comprise and/or refer to any suitable information configured to characterize the behavior of SC 30 of an MD 20 during operation under specified operating conditions. For example, a “nominal” SC signature 430 of an SC 30 may be configured to characterize behavior of the SC 30 during nominal, non-anomalous operation of the MD 20. By contrast, an “anomalous” SC signature 430 may be configured to characterize behavior of the SC 30 during operation of the MD 20 under anomalous operating conditions (e.g., under threat conditions, attack, compromise, failure, or the like). SC signatures 430 may comprise and/or be derived from SCM data 130 acquired during operation of the MD 20 under known operating conditions, e.g., by an SCM system 140, as illustrated in FIG. 2. For example, “nominal” SC signatures 430 for an MD 20 may be generated and/or derived from SCM data 130 acquired from the MD 20 during nominal, non-anomalous operation of the MD 20. By contrast, “anomalous” SC signatures 430 may be generated and/or derived from SCM data 130 acquired from the MD 20 during operation under anomalous operating conditions (e.g., may comprise SCM data 130 acquired while the MD 20 is subject to threat, attack, cyber-attack, physical-attack, compromise, failure conditions, and/or the like). Alternatively, or in addition, the SCS module 120 may be configured to generate and/or derive one or more SC signatures 430 from synthetic SC data as disclosed in United States Provisional Patent Application No. 63,570,790 filed Mar. 27, 2024.

In the implementation illustrated in FIG. 4, the SCS module 120 may comprise and/or be coupled to a complimentary SC assessment (CSCA) module 410, which may be configured to assess the behavior of a plurality of SC 30 of the MD 20. The CSCA module 410 may comprise one or more SC assessment (SCA) modules 420, each configured to assess the behavior of a respective SC 30 of the MD 20. In the FIG. 4 example, the CSCA module 410 may comprise N SCA modules 420A-N configured to assess the behavior of SC 30A-N, respectively. The SCA modules 420 may be configured to assess the behavior of respective SC 30 by any suitable method or technique. For example, the SCA modules 420 may be configured to compare SCM data 130 acquired from the MD 20 to “nominal” SC signatures 430; the SCA module 420A may be configured to compare the SCM data 130A acquired from SC 30A to a “nominal” SC signature 430A determined for the SC 30A, the SCA module 420N may be configured to compare the SCM data 130N acquired from SC 30N to a “nominal” SC signature 430N determined for SC 30N, and so on.

The SCA modules 420 may be further configured to generate SC health metrics 450 for respective SC 30. The SC health metrics 450 may be configured to indicate a degree to which the SCM data 130 acquired from a specified SC 30 of the MD 20 are indicative of healthy operation of the MD 20 (e.g., nominal, non-anomalous operating conditions); the SCA module 420A may be configured to generate SC health metrics 450A configured to indicate a degree to which the behavior of SC 30A is indicative of a threat and/or anomaly, the SCA module 420N may be configured to generate SC health metrics 450N configured to indicate a degree to which the behavior of SC 30N is indicative of a threat and/or anomaly, and so on. By way of non-limiting example, the SCA modules 420 may be configured to generate SC health metrics 450 configured to quantify error between the behavior exhibited by respective SC 30 of the MD 20 and corresponding “nominal” SC signatures 430. In other words, the SC health metrics 450 may indicate a degree to which the behavior exhibited by respective SC 30 deviates from “nominal” behavior of the SC 30. The SCA modules 420A-N may be configured to quantify error by any suitable means including, but not limited to a: difference, distance, root mean square (RMS) error, Euclidian distance, average error, running error, cumulative error, and/or the like. In some implementations, the SCA modules 420A-N may be further configured to detect threats and/or anomalies in response to generating SC health metrics 450A-N that satisfy a detection threshold, e.g., per Eq. 1 and 2 below:

$${E}_{{NOM}_{i}} = {f}_{i} ( {m}_{i} , {SIG}_{{NOM}_{i}} ) \qquad Eq . 1$$

$${X}_{i} ← {E}_{{NOM}_{i}} \geq {E}_{{Th}_{i}} \qquad Eq . 2$$

In Eq. 1, mᵢ represents SCM data 130-i pertaining to SC 30-i acquired from the MD 20, SIG_{NOM}_{ᵢ} represents an SC signature 430-i configured to characterize behavior of SC 30-i during nominal, non-anomalous operating conditions (e.g., a “nominal” SC signature 430), E_{NOM}_{ᵢ} is an error between the observed behavior of SC 30-i and the “nominal” SC signature 430-i, and ƒᵢ is a function by which the error metric (E_{NOM}_{ᵢ}) is determined by the SCA module 420-i (e.g., distance, RMS error, running error, or the like). In Eq. 2, Xᵢ represents trigger criterion for detection of a threat and/or anomaly based on the behavior of SC 30-i and E_{Th}_{ᵢ} is an error threshold for SC 30-i. The SC health metrics 450-i determined for SC 30-i may comprise error metrics (E_{NOM}_{ᵢ}), the trigger criteria (Xᵢ), and/or the like.

In some implementations, the SCS module 120 may be configured to trigger detection of a threat and/or anomaly in response to detection of a threat and/or anomaly by any of the SCA modules 420A-N. Alternatively, or in addition, in some implementations, the SCS module 120 may comprise and/or be coupled to a combined assessment (CA) module 440. The CA module 440 may be configured to assess the combined behavior of multiple SC 30, e.g., assess the behavior of SC 30A-N. For example, the CA module 440 may be configured to determine health metrics 150 for the MD 20 based, at least in part, on the SC health metrics 450A-N generated for respective SC 30A-N. The CA module 440 may be configured to generate health metrics 150 according to any suitable method or technique. The CA module 440 may be configured to generate health metrics 150 according to CSCA logic 442. In some implementations, the CA module 440 may be configured to aggregate and/or combine the SC health metrics 450A-N determined for respective SC 30A-N, which may comprise one or more operations including, but not limited to: averaging the SC health metrics 450A-N, weighting the SC health metrics 450A-N (e.g., assigning respective weights to the SC health metrics 450A-N based on, inter alia, user and/or machine-learned experience), performing a statistical analysis of the SC health metrics 450A-N (e.g., mapping the SC health metrics 450A-N to a statistical distribution or the like), determining value range(s) based on the SC health metrics 450A-N, selecting maximum values from the SC health metrics 450A-N (e.g., selecting SC health metrics 450A-N most indicative of a threat and/or anomaly), selecting minimum values from the SC health metrics 450A-N, and/or the like. By way of non-limiting example, the CA module 440 may be configured to derive health metrics 150 from SC health metrics 450A-N according to Eq. 3 below:

$$H = {f}_{H} ( {E}_{{NOM}_{A}} , ... , {E}_{{NOM}_{N}} ) \qquad Eq . 3$$

In Eq. 3, ƒ_{H} represents a function implemented by the CSCA logic 442 to, inter alia, derive health metrics 150 (H) for the MD 20 from SC health metrics 450A-N (E_{NOM}_{_{A}}, . . . , E_{NOM}_{_{N}}) determined for respective SC 30A-N of the MD 20. In the Eq. 3 example, the health metrics 150 (H) may quantify error between the behavior exhibited by SC 30A-N of the MD 20 and SC behavior characteristic of “nominal” operating conditions and, as such, the SCS module 120 may be configured to trigger detection of a threat and/or anomaly when the error quantified by the health metrics 150 (H) exceeds a threshold, e.g., X←H≥E_{TH}_{_{SC}}, where X represents threat and/or anomaly detection criteria configured to trigger detection when observed SC behavior deviates from SC behavior characteristic of “nominal” operating conditions by more than a SC threshold (E_{TH}_{_{SC}}). The function (ƒ_{H}) may comprise any suitable means for deriving health metrics 150 from SC health metrics 450A-N, as disclosed herein. For example, the CA module 440 may be configured to combine the SC health metrics 450A-N, e.g., may comprise CSCA logic 442 configured to determine a weighted average or the like, as illustrated in Eq. 4:

$$H = \frac{1}{N} {\sum }_{i = 1}^{N} {w}_{i} {E}_{{NOM}_{i}} \qquad Eq . 4$$

In Eq. 4, wᵢ represents a weight assigned to the SC health metrics 450-i determined for SC 30-i (E_{NOM}_{ᵢ}). In some implementations, the CA module 440 may be configured to compare the SC health metrics 450A-N to respective thresholds and may generate health metrics 150 indicative of detection of a threat and/or anomaly in response to determining that one or more of the SC health metrics 450A-N satisfies its corresponding detection threshold, e.g., per Eq. 5 below:

$$X ← ( {E}_{{NOM}_{A}} \geq {E}_{{Th}_{A}} ) ∨ ... ( {E}_{{NOM}_{N}} \geq {E}_{{Th}_{N}} ) \qquad Eq . 5$$

In Eq. 5, X represents trigger criterion for detection of a threat and/or anomaly by the SCS module 120, E_{NOM}_{_{A}} through E_{NOM}_{_{N}} represent error metrics determined for respective SC 30A-N (e.g., error between observed behavior of SC 30A-N and corresponding “nominal” SC signatures 430A-N), and E_{Th}_{_{A}} through E_{Th}_{_{N}} represent error thresholds for respective SC 30A-N. Although particular examples of means for deriving health metrics from 150 and/or triggering detection of threats and/or anomalies based on the behavior of multiple SC 30 (e.g., SC health metrics 450A-N) are described herein, the disclosure is not limited in this regard and could be adapted to assess the behavior of multiple SC using any suitable method or technique.

As disclosed herein, the behavior exhibited by SC 30 of an MD 20 may be characteristic of the operating conditions of the MD 20. In other words, the behavior one or more SC 30 during “nominal” operation of the MD 20 may be distinguishable from behavior exhibited under “anomalous” conditions, e.g., operation of the MD 20 under anomalies such as attack, compromise, failure conditions, or the like. SC behavior, however, may be impacted by other factors. For example, different types of MD 20 may exhibit different SC behavior; MD 20 of the same device type 25 may exhibit the same or similar SC behavior, which may differ significantly from the SC behavior exhibited by other device types 25. Moreover, the SWM 21 implemented by an MD 20 may impact SC behavior; the SC behavior of an MD 20 may be affected by the settings, configuration, firmware, machine-executable instructions and/or other aspects of the SWM 21 implemented by the MD 20.

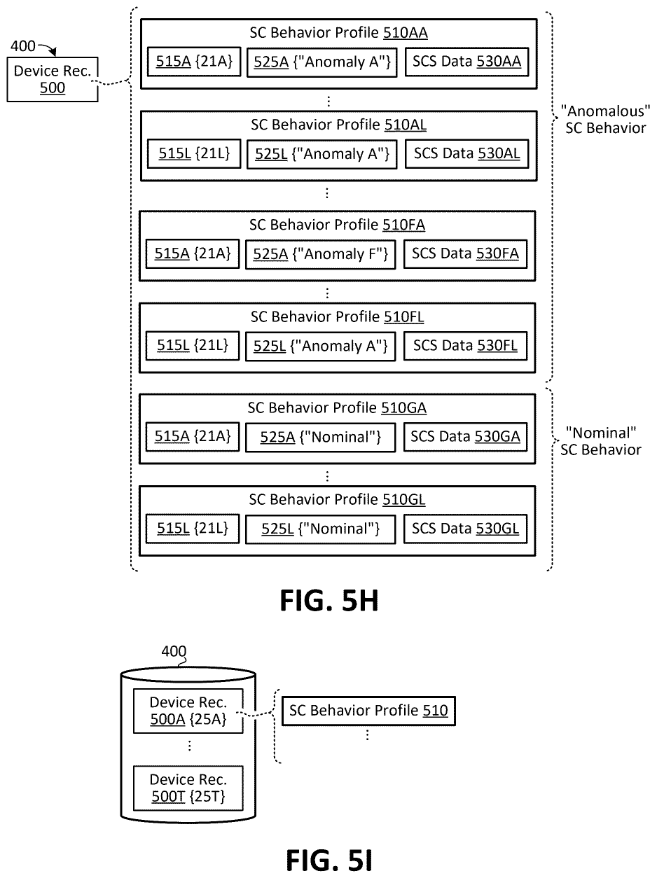

In some implementations, the SCS module 120 may be configured to maintain and/or retrieve information pertaining to the SC behavior of MD 20 within DSR resources, such as a datastore 400. FIGS. 5A-5I comprise schematic block diagrams illustrating examples of a datastore 400 configured to maintain information pertaining to the SC behavior of MD 20.

Information pertaining to SC behavior of a MD 20 may be maintained in any suitable format and/or scheme. In the FIG. 5A example, the datastore 400 may be configured to store information pertaining to device types 25 within respective records (e.g., device records 500). A device record 500 may comprise any suitable information pertaining to a device type 25 such as an identifier (e.g., a name, unique identifier, version number, and/or the like), an instruction set architecture (ISA) supported by the device type 25 (if any), and so on. Device records 500 may further comprise and/or reference SC behavior (SCB) profile(s) 510 comprising information pertaining to the SC behavior of the MD 20 under specified operating conditions. As illustrated in FIG. 5A, an SCB profile 510 may comprise and/or reference SC signature (SCS) data 530. The SCS data 530 may comprise SC signatures 430 characteristic of SC behavior of the MD 20 under operating conditions defined by, inter alia, health metadata (MD) 525. As used herein, health MD 525 may comprise any suitable information operating to the operating conditions or operating state of an MD 20 including, but not limited to: an identifier, a name, semantic data, a semantic label, a classification, a classification label, a tag, a category, a taxonomic grouping, and/or the like. For example, a SCB profile 510 configured to characterize SC behavior under nominal, non-anomalous operating conditions may comprise “nominal” health MD 525 (e.g., may comprise a “nominal” semantic label, classification, or the like as illustrated in FIG. 5B). Conversely, an SCB profile 510 configured to characterize SC behavior under anomalous operating conditions may comprise “anomalous” health MD 525 (e.g., may comprise an “anomalous” semantic label and/or semantic label(s) configured to identify specified anomalous operating conditions such as operation under a specified type of threat, attack, cyber-attack, network attack, physical attack, compromise, failure condition, and/or the like).

FIG. 5B illustrates an example of an SCB profile 510 configured to characterize SC behavior of a device type 25 under nominal, non-anomalous operating conditions. In other words, the SCB profile 510 may comprise a “nominal” SCB profile 510-NOM. The SCB profile 510-NOM of the FIG. 5B example may comprise “nominal” health MD 525. The SCB profile 510-NOM may further comprise and/or reference SCS data 530 comprising “nominal” SC signatures 430. The SCM profile 510-NOM illustrated in the FIG. 5B example may comprise SCS data 530-NOM configured to characterize nominal, non-anomalous operating conditions of the MD 20. The SCS data 530-NOM may comprise SC signatures 430A-N configured to characterize the behavior exhibited by SC 30A-N of a device type 25 during nominal, non-anomalous operation. As disclosed herein, the SC signatures 430A-N may comprise and/or be derived from SCM data 130 acquired during nominal operation of an MD 20 of the device type 25, e.g., may comprise SCM data 130 acquired by an SCM system 140, as illustrated in FIG. 2. Alternatively, or in addition, aspects of the SC signatures 430A-N may comprise and/or be derived from synthetic SC data, as disclosed herein.

Although examples of SCS data 530 configured to characterize nominal operating conditions are described herein, the disclosure is not limited in this regard and could be adapted to capture, record, and/or utilize SCS data 530 corresponding to other operating conditions. FIG. 5C is a schematic block diagram illustrating an example of an SCB profile 510 configured to characterize SC behavior of a device type 25 under anomalous operating conditions. In other words, the SCB profile 510 illustrated in the FIG. 5C example may comprise an “anomalous” SCB profile 510-ANM configured to characterize anomalous SC behavior of the MD 20. The SCB profile 510-ANM illustrated in FIG. 5C may comprise and/or reference SCS data 530-ANM comprising SC signatures 430A-N configured to characterize the behavior of SC 30A-N of the device type 25 under anomalous operating conditions. For example, SC signatures 430A-N of the SCS data 530-ANM may comprise and/or be derived from SCM data 130 acquired from MD 20 of the device type 25 under operating conditions corresponding to known threats and/or anomalies, e.g., under known threats, attacks, cyber-attacks, physical attacks, network attacks, compromise condition(s), failure condition(s), and/or the like.

Referring back to FIG. 4, in some implementations, the SCS module 120 may be configured to detect threats and/or anomalies by, inter alia, comparing the behavior of one or more SC 30A-N of the MD 20 to SC signatures 430A-N configured to characterize nominal, non-anomalous operation of the MD 20. The SCS module 120 may be configured to retrieve information pertaining to “nominal” SC behavior from a datastore 400. For example, the SCS module 120 may be configured to retrieve SC signatures 430A-N configured to characterize the behavior of SC 30A-N under nominal operating conditions from an SCB profile 510, such as the “nominal” SCB profile 530-NOM illustrated in FIG. 5B.

Alternatively, or in addition, the SCS module 120 may be configured to compare the behavior of respective SC 30 of the MD 20 to SC signatures 430 configured to characterize other, anomalous operating conditions. For example, the SCS module 120 may be configured to compare the behavior exhibited by SC 30A-N of the MD 20 to SC signatures 430A-N configured to characterize SC behavior of the MD 20 under anomalous operating conditions, e.g., operating conditions indicative of a threat, attack, compromise, failure, or the like. For example, the SCS module 120 may be configured to retrieve SC signatures 430A-N configured to characterize the behavior of SC 30A-N under anomalous operating conditions from an “anomalous” SCB profile 510, such as the “anomalous” SCB profile 510-ANM illustrated in FIG. 5C. In these implementations, the SCS module 120 may be configured to trigger detection of a threat and/or anomaly in response to determining that the behavior of one or more SC 30 of the MD 20 corresponds to an “anomalous” SC signature 430, e.g., one or more SC 30 exhibit behavior within a proximity threshold to known anomalous behavior.

By way of non-limiting example, the SCA modules 420A-N may be configured to compare SCM data 130A-N acquired from the MD 20 to “anomalous” SC signatures 430A-N determined for the device type 25. The SCA modules 420A-N may be further configured to generate SC health metrics 450A-N that, inter alia, indicate a degree to which the SCM data 130A-N acquired from the MD 20 corresponds with anomalous SC behavior, e.g., per Eq. 6 and 7 below:

$${E}_{{ANM}_{i}} = {f}_{i} ( {m}_{i} , {SIG}_{{ANM}_{i}} ) \qquad Eq . 6$$

$${X}_{i} ← {E}_{{ANM}_{i}} \leq {P}_{{TH}_{i}} \qquad Eq . 7$$

In Eq. 6, mᵢ represents SCM data 130-i pertaining to SC 30-i acquired from the MD 20, SC_{ANM}_{ᵢ} represents an SC signature 430-i configured to characterize behavior of SC 30-i during anomalous operation of the MD 20 (e.g., an “anomalous” SC signature 430), E_{A}_{ᵢ} represents error between the SCM data 130-i and SC signature 430-i, and ƒᵢ is a function by which the error metric (E_{ANM}_{ᵢ}) is determined by the SCA module 420-i (e.g., distance, RMS error, running error, or the like). In Eq. 7, Xᵢ represents trigger criterion for detection of a threat and/or anomaly based on the behavior of SC 30-i and P_{TH}_{ᵢ} is a proximity threshold for SC 30-i. The P_{TH}_{ᵢ} threshold may be configured to trigger detection of a threat and/or anomaly in response to determining that the observed behavior of SC 30-i is within a threshold proximity and/or error of the corresponding “anomalous” SC signature 430-i.

In some implementations, the CA module 440 may be configured to trigger detection of a threat and/or anomaly in response to determining that one or more SC 30A-N of the MD 20 are exhibiting behavior within a threshold of corresponding “anomalous” SC signatures 430A-N, e.g., per Eq. 8 below:

$$X ← ( {E}_{{ANM}_{A}} \leq {P}_{{TH}_{A}} ) ∨ ... ( {E}_{{ANM}_{N}} \leq {P}_{{Th}_{N}} ) \qquad Eq . 8$$

In Eq. 8, X represents trigger criterion for detection of a threat and/or anomaly by the SCS module 120, E_{ANM}_{_{A}} through E_{ANM}_{_{N}} represent error metrics determined for respective SC 30A-N relative to corresponding “anomalous” SC signatures 430A-N, and P_{Th}_{_{A}} through P_{Th}_{_{N}} represent proximity thresholds for respective SC 30A-N. Alternatively, or in addition, the CA module 440 may be configured to generate health metrics 150 that are based, in least in part, on the SC health metrics 450A-N generated by SCA modules 420A-N. The CA module 440 may be configured to aggregate and/or combine the SC health metrics 450A-N determined for respective SC 30A-N, as disclosed herein. The health metrics 150 may be configured to indicate a degree to which SC behavior of the MD 20 corresponds to SC behavior characteristic of anomalous operating conditions.

Although particular examples of means for generating health metrics 150 from SC health metrics 450 are described herein, the disclosure is not limited in this regard and could be adapted to derive health metrics 150 (and/or trigger detection of a threat and/or anomaly) based on a plurality of SC health metrics 450A-N by any suitable method or technique. In some implementations the SCS module 120 may be configured to compare the SCM data 130 acquired from the MD 20 to SCS data 530 corresponding to different types of operating conditions. For example, the SCS module 120 may retrieve SCS data 530 characteristic of the SC behavior exhibited by the MD 20 under “nominal” operating conditions from an “nominal” SCB profile 510-NOM and retrieve SCS data 530 characteristic of SC behavior under “anomalous” operating conditions from an “anomalous” SCB profile 510-ANM, as illustrated in FIG. 5D. In these implementations, the SCA modules 420A-N may be configured to generate SC health metrics 450A-N that indicate a degree to which the behavior of SC 30A-N correspond to nominal and/or anomalous operation. For example, the SCA modules 420A-N may assess a relative proximity of observed SC behavior to respective SC signatures 430, as follows:

$${E}_{{NOM}_{i}} = {f}_{i} ( {m}_{i} , {SIG}_{{NOM}_{i}} ) \qquad Eq . 9$$

$${E}_{{ANM}_{i}} = {f}_{i} ( {m}_{i} , {SIG}_{{ANM}_{i}} )$$

$${X}_{i} ← ( {E}_{{NOM}_{i}} - {E}_{{ANM}_{i}} ) \geq {BP}_{{Th}_{i}}$$

In Eq. 9, E_{NOM}_{ᵢ} represents error between the behavior exhibited by SC 30-i and “nominal” SC behavior (SIG_{NOM}_{ᵢ}), E_{ANM}_{ᵢ} represents error between the behavior exhibited by SC 30-i and “anomalous” SC behavior (SIG_{ANM}_{ᵢ}), and Xᵢ is trigger criterion configured to detect a threat and/or anomaly based on the relative proximity of SC 30-I to “nominal” and “anomalous” SC behaviors, respectively, e.g., when error relative to “nominal” SC behavior (E_{NOM}_{ᵢ}) exceeds error relative to “anomalous” SC behavior (E_{ANM}_{ᵢ}) by more than a behavior threshold (BP_{Th}_{ᵢ}). Although particular examples of techniques for comparing observed SC behavior to SCS data 530 characteristic of respective operating conditions are described herein, the disclosure is not limited in this regard and could be adapted to perform such comparisons using any suitable method and/or technique.

In some implementations, the SCS module 120 may be further configured to detect particular types of threats and/or anomalies. For example, the SCS module 120 may be configured to compare SC behavior exhibited by the MD 20 to SCS data 530 characteristic of designated types of threats and/or anomalies and, in response, generate health metrics 150 indicating a degree to which the SC behavior corresponds with SC behavior characteristic of the such threats and/or anomalies. The SCA module 420 may be capable of retrieving information pertaining to SC behavior under operating conditions corresponding to respective threats and/or anomalies from any suitable source such as the datastore 400 disclosed herein.

FIG. 5E is a schematic block diagram illustrating an example of a datastore 400 configured to maintain information pertaining to the SC behavior of the MD 20 of a device type 25 under a plurality of different operating conditions. The device record 500 illustrated in the FIG. 5E example comprises SCB profiles 510A-F, which may be configured to characterize the SC behavior of the device type 25 under respective types of “anomalous” operating conditions, e.g., under respective types of threats, attacks, failures, and/or other types of anomalies labeled “Anomaly A” through “Anomaly F” in FIG. 5E. By way of non-limiting example, the SCB profile 510A may be configured to characterize SC behavior during a particular type of attack (e.g., attack through a designated attack vector per the “Anomaly A” health MD 525A) and the SCS data 530A may comprise SC signatures 430 acquired from an MD 20 during the particular type of attack; the SCB profile 510F may be configured to characterize SC behavior of the device type 25 during a particular type of failure condition (e.g., sensor error, actuator failure, or the like) and the SCS data 530F may comprise SC signatures 430 acquired from an MD 20 of the DA during the particular type of failure condition. In some implementations, the datastore 400 may further comprise an SCB profile 510-NOM comprising SCS data 530-NOM configured to characterize SC behavior under “nominal” operating conditions, as disclosed herein. The “nominal” SCB profile 510-NOM may further comprise “nominal” health MD 525-NOM.

Referring back to FIG. 4, the SCS module 120 may be configured to compare the SC behavior exhibited by the MD 20 (e.g., SCM data 130A-N) to SC signatures 430 characteristic of respective operating conditions and generate health metrics 150 based, at least in part, on the comparing. For example, the SCA modules 420A-N may be configured to compare the SCM data 130A-N acquired from respective SC 30A-N to SC signatures 430A-N of respective SCB profiles 510, such as the SCB profiles 510A-F and/or 510-NOM illustrated in FIG. 5E. The SCA modules 420A-N may be further configured to generate SC health metrics 450A-N indicating a degree to which the behavior of respective SC 30A-N corresponds with anomalous SC behavior (as opposed to nominal SC behavior). For example, the SC health metrics 450A-N may indicate a degree to which SC 30A-N correspond with behaviors characteristic of “Anomaly A” through “Anomaly F,” respectively. Alternatively, or in addition, the SC health metrics 450A-N may indicate a degree to which respective SC 30A-N correspond with the “nominal” SC behavior of SCB profile 510-NOM, quantify a relative proximity of observed SC behavior to respective SCB profiles 510, and/or the like.

The SCS module 120 may be further configured to generate health metrics 150 for the MD 20 based, at least in part, on the SC health metrics 450A-N determined for respective SC 30A-N. The health metrics 150 may indicate a degree to which the SC behavior exhibited by the MD 20 corresponds with the SC signatures 430 configured to characterize specified SC behaviors, e.g., per Eq. 1, 6, and/or 9 above. The health metrics 150 may be configured to trigger detection of a threat and/or anomaly in response to determining that SC behavior of the MD 20 corresponds more closely to “anomalous” SC behavior than “nominal” SC behavior (e.g., per comparison with respective SCB profiles 510A-F and/or 510-ANM). The health metrics 150 may be further configured to identify the SCB profile 510 having a closest proximity to the SC behavior exhibited by the MD 20, e.g., may indicate a particular threat, attack, compromise, failure, and/or other anomalous operating condition per the health MD 525 of the identified SCB profile 510.

As disclosed herein, the SC behavior of an MD 20 may also be impacted by the SWM 21 implemented thereby; the SWM 21 implemented by an MD 20 may determine the settings, configuration, firmware and/or other machine-executable instructions implemented by the MD 20 which, in turn, may impact the behavior of one or more SC 30. In some implementations, the SCS module 120 may be configured to evaluate SC behavior of the MD 20 based on, inter alia, the SWM 21 implemented by the MD 20. The SCS module 120 may be configured to retrieve information pertaining to the SC behavior of the MD 20 during implementation of respective SWM 21 from a suitable source such as the datastore 400 or the like.

FIG. 5F is a schematic block diagram illustrating an example of a datastore 400 comprising information pertaining to the SC behavior of a specified type of MD 20 (e.g., device type 25) during execution of specified SWM 21. As illustrated in the FIG. 5F example, an SCB profile 510 may comprise device configuration MD 515. As used herein, device configuration metadata (DCMD) 515 may comprise and/or refer to information pertaining to the configuration of an MD 20, which may include, but is not limited to information pertaining to: device type 25 of the MD 20, version or revision of the MD 20, SWM 21 implemented by the MD 20, firmware implemented by the MD 20, the configuration and/or settings of the MD 20, and so on. In other words, the device records 500 associated with a specified type of MD 20 may comprise SCB profiles 510 configured to characterize SC behavior of the device type 25 during operation under specified configurations, e.g., during implementation of respective SWM 21. The device record 500 determined for a particular type of MD 20 may comprise a plurality of SCB profiles 510, each configured to characterize SC behavior of the MD 20 during operation according to specified DCMD 515. For example, the device record 500 associated with a particular type of MD 20 may comprise SCB profiles 510 configured to characterize nominal, non-anomalous SC behavior of the MD 20 during execution of specified SWM 21.

By way of further non-limiting example, the device record 500 illustrated in FIG. 5G comprises L SCB profiles 510-NOM-A through 510-NOM-L comprising SCS data 530-NOM-A through 530-NOM-L configured to characterize “nominal” SC behavior of the device type 25 during implementation of different SWM 21. The SCB profiles 510-NOM-A through 510-NOM-L may be configured to characterize nominal, non-anomalous SC behavior of the device type 25 during execution of SWM 21A-L, respectively (e.g., as indicated by DCMD 515A-L, respectively); the SCS dataset 530A may comprise SC signatures 430 configured to characterize nominal, non-anomalous behavior of respective SC 30A-N during implementation of SWM 21A, the SCS dataset 530L may comprise SC signatures 430 configured characterize nominal, non-anomalous behavior of respective SC 30A-N during implementation of SWM 21L, and so on.

Referring back to FIG. 4, in some implementations, the SCS module 120 may be configured to compare the SC behavior exhibited by the MD 20 to SCS data 530 characteristic of nominal, non-anomalous operation during implementation of specified SWM 21. For example, the SCS module 120 may be configured to identify the SWM 21 implemented by the MD 20 and compare the SCM data 130 to the SCS data 530 configured to characterize SC behavior during nominal, non-anomalous implementation of the identified SWM 21, as disclosed herein. The SCS module 120 may identify the SWM 21 implemented by the MD 20 by any suitable mechanism. For example, the SCS module 120 may be configured with information pertaining to the SWM 21 implemented by the MD 20 monitored thereby (e.g., information pertaining to the DA 25 and/or SWM 21 of respective MD 20 may be provided to the SCS module 120). In some implementations, the SCS module 120 may be configured to retrieve information pertaining to the MD 20 from the datastore 400 and/or the MD 20 itself (e.g., may query the datastore 400 and/or MD 20), e.g., may be configured to “pull” information pertaining to the MD 20 from one or more data sources. Alternatively, or in addition, information pertaining to the MD 20 may be “pushed” to the SCS module 120, e.g., the MD 20 and/or other component(s) of the MS 40 may be configured to transmit and/or broadcast information pertaining to the MD 20 to the SCS module 120.

In some implementations, the SCS module 120 may not be aware of the SWM 21 being implemented by the MD 20. In these implementations, the SCS module 120 may be configured to compare the SC behavior of the MD 20 to SCS data 530 corresponding to nominal, non-anomalous implementation of a plurality of different SWM 21. In the FIG. 4 example, the SCS module 120 may compare the SCM data 130 acquired from the MD 20 to SCS datasets 530A-1 through 530A-L, e.g., compare against SC behavior characteristic of nominal, non-anomalous implementation of SWM 21-1 through 21-L, respectively. The SCS module 120 may trigger detection of a threat and/or anomaly based on the comparing, e.g., may trigger detection if error between the SCM data 130 and the SCS datasets 530-1 through 530-L fail to satisfy error thresholds, as disclosed herein.

Although particular examples of SCB profiles 510 (and SCS data 530) corresponding to “nominal” implementation of respective SWM 21 are disclosed herein, the disclosure is not limited in this regard and could be adapted to utilize other SCB profiles 510 configured to characterize SC behavior of MD 20 under other operating conditions, such as anomalous operating conditions corresponding to implementation of designated SWM 21. For example, a device record 500 may comprise and/or reference SCB profiles 510 configured to characterize SC behavior under specified types of anomalies and/or under specified device configurations, e.g., during implementation of respective SWM 21A-L.

FIG. 5H is a schematic block diagram illustrating another example of a device record 500. In the FIG. 5H example, the device record 500 is associated with SC behavior profiles 510AA-FL, which may be configured to characterize SC behavior under specified types of anomalies; the SCS data 530AA-AL may be configured to characterize SC behavior under operating conditions corresponding to “Anomaly A” during execution of respective SWM 21A-L (as indicated by the device configuration MD 515A-L associated therewith); the SCB profiles 510FA-FL may be configured to characterize SC behavior under operating conditions corresponding to “Anomaly F” during execution of respective SWM 21A-L; and so on.

In the FIG. 5H example, the device record 500 may further comprise SCB profiles 510GA-GL. The SCB profiles 510GA-GL may be configured to characterize SC behavior under nominal, non-anomalous operating conditions during execution of respective SWM 21A-L. For example, the SCS data 530GA-GL may be configured to characterize SC behavior exhibited during “nominal” execution of SWM 21A-L, respectively.

Referring back to FIG. 4, the SCS module 120 may be configured to identify the SWM 21 implemented by the MD 20 and compare the SC behavior exhibited by the MD 20 to SC signatures 430 of corresponding SCB profiles 510, e.g., SC signatures 430 configured to characterize operating conditions during execution of the identified SWM 21. The SCS module 120 may be configured to compare the acquired SCM data 130 to SC signatures 430 characteristic nominal, non-anomalous operating conditions. For example, the SCS module 120 may compare the acquired SCM data 130 to one or more “nominal” SCB profiles 510GA-GL in accordance with the DCMD 515 of the MD 20. Alternatively, or in addition, the SCS module 120 may compare the acquired SCM data 130 to one or more “anomalous” SCB profiles 510AA-FL configured to characterize SC behavior of the MD 20 during execution under specified DCMD 515 under operating conditions associated with specified types of anomalies (e.g., “Anomaly A” through “Anomaly F”), as disclosed herein in conjunction with FIG. 5E.

In some implementations, the SCS module 120 may be configured to monitor different types of MD 20. The SCS module 120 may be configured to retrieve information pertaining to the SC behavior of respective device types 25 from a suitable source, such as the datastore 400 disclosed herein. As disclosed herein, the datastore 400 may comprise device records 500, each comprising information pertaining to the SC behavior of a respective type of MD 20 (e.g., a respective device type 25). FIG. 5I is a schematic block diagram illustrating an example of a datastore 400 comprising information pertaining to T device types 25. The datastore of the FIG. 5I example may comprise T device records 500A-T, which may comprise information pertaining to the SC behavior of device types 25A-T, respectively. The device records 500A-T may comprise and/or reference SCB profiles 510, which may comprise SCS data 530 configured to characterize the SC behavior of respective device types 25A-T under respective operating conditions (e.g., per health MD 525) and/or during implementation of respective device configurations (e.g., per device configuration MD 515). The SCB profiles 510 may be configured to characterize SC behavior under “nominal” operating conditions, “anomalous” operating conditions, specified types of anomalies (e.g., “Anomaly A” through “Anomaly F”), and/or the like.

Although specific examples of techniques for assessing SC behavior are described herein (e.g., techniques for comparing SC behavior exhibited by an MD 20 to SC signatures 430 characteristic of specified operating conditions of the MD 20), the disclosure is not limited in this regard and could be adapted to detect threats and/or anomalies using any suitable approach. For example, in some implementations, the SCS module 120 may be configured to detect threats and/or anomalies using artificial intelligence, machine-learning, and/or machine-learned (AI/ML) components.

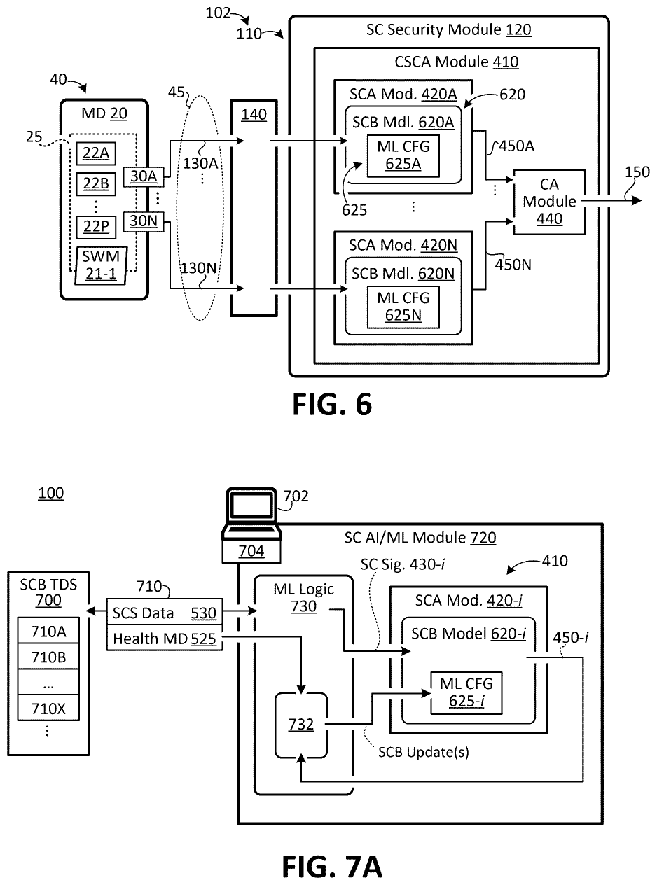

FIG. 6 is a schematic block diagram illustrating an example of a system 100 comprising an SCS module 120 configured to detect threats and/or anomalies based using, inter alia, machine-learned SC behavior models 620. As used herein, an SC behavior (SCB) model 620 may comprise and/or refer to any suitable AI/ML means for characterizing the behavior of one or more SC 30 of an MD 20 including, but not limited to: a supervised learning AI/ML architecture, an unsupervised AI/ML architecture, a reinforcement AI/ML architecture, a deep learning AI/ML architecture, generative adversarial networks (GANs), an autoencoder, a variational autoencoder (VAE), an autoregressive model, an artificial neural network (ANN), a convolutional neural network (CNN), a recurrent or recursive neural network (RNN), a generative model, a discriminator, a classifier, and/or the like.

The SCB models 620 may be configured to generate SC health metrics 450 in response to SCM data 130 acquired from the MD 20. In the FIG. 6 example, the CSCA module 410 may comprise N SCB models 620A-N, which may be configured to generate SC health metrics 450A-N for SC 30A-N based, at least in part on the SCM data 130A-N acquired from the MD 20.

In some implementations, one or more of the SCB modules 620A-N may be trained to learn “nominal” behavior of respective SC 30. For example, the SCB modules 620A-N may be configured to generate SC health metrics 450A-N that indicate a degree to which the SCM data 130A-N acquired from respective SC 30A-N corresponds with SC behavior characteristic of “nominal” operating conditions, e.g., the SC health metrics 450A-N may be configured to indicate a degree to which SC behavior corresponds to nominal, non-anomalous operation of the MD 20.

Alternatively, or in addition, one or more of the SCB modules 620A-N may be trained to learn “anomalous” behavior of respective SC 30. For example, the SCB modules 620A-N may be configured to generate SC health metrics 450A-N that indicate a degree to which the SCM data 130A-N acquired from respective SC 30A-N corresponds with SC behavior characteristic of “anomalous” operating conditions, e.g., the SC heath metrics 450A-N may be configured to indicate a degree to which SC behavior corresponds to operation under a threat and/or anomaly.

Alternatively, or in addition, one or more of the SCB modules 620A-N may be trained to learn “nominal” and “anomalous” behavior of respective SC 30. For example, the SCB modules 620A-N may be configured to generate SC health metrics 450A-N that indicate a degree to which the SCM data 130A-N acquired from respective SC 30A-N corresponds with SC behavior characteristic of “nominal” and/or “anomalous” operating conditions, e.g., may indicate a proximity of the behavior exhibited by respective SC 30A-N to SC behavior characteristic of “nominal” operating conditions relative to SC behavior characteristic of “anomalous” operating conditions.

Alternatively, or in addition, one or more of the SCB modules 620A-N may be trained to learn SC behavior corresponding to specified types of anomalous operating conditions. The SCB modules 620A-N may be configured to learn SC behavior characteristic of “anomalous” operating conditions corresponding to designated types of threats, attacks, cyber-attacks, physical attacks, compromise, failure conditions, and/or the like. For example, the SCB modules 620A-N may be configured to learn SC behaviors characteristic of operating conditions corresponding to “Anomaly A” through “Anomaly F,” as illustrated in FIGS. 5E and 5H. The SCB modules 620A-N may be configured to generate SC health metrics 450A-N that indicate a degree to which the SCM data 130A-N acquired from respective SC 30A-N corresponds with SC behavior characteristic of respective types of “anomalous” operating conditions. In some implementations, the SCB modules 620A-N may be further configured to learn SC behaviors characteristic “nominal” operating conditions and the SC health metrics 450A-N generated thereby may be configured to indicate a degree to which SC behavior corresponds to “nominal” operating conditions and/or one or more “anomalous” operating conditions.

The CSCA module 410 illustrated in the FIG. 6 example may further comprise a CA module 440. In some implementations, the CA module 440 may be configured to generate health metrics 150 for the MD 20 from the SC metrics 450A-N determined for respective SC 30A-N of the MD 20. For example, the CA module 440 may be configured to generate health metrics 150 for the MD 20 in accordance with CSCA logic 442 as described above in conjunction with FIG. 4. In some implementations, the CA module 440 may be configured to trigger detection of a threat and/or anomaly in response to detection of a threat and/or anomaly by one or more of the SCB models 420A-N. For example, the CA module 440 may be configured to detect a threat and/or anomaly in response to determining that: a) error between the behavior exhibited by one or more SC 30A-N deviates from SC behavior characteristic of “nominal” operating conditions by more than a threshold; b) behavior exhibited by one or more SC 30A-N is within a proximity threshold of SC behavior characteristic of “anomalous” operating conditions; c) behavior exhibited by one or more SC 30A-N corresponds to SC behavior characteristic of “anomalous” operating conditions more closely than SC behavior characteristic of “nominal” operating conditions, and/or the like.

The SCB models 620 may be trained to convert SCM data 130 into SC health metrics 450 that accurately characterize SC behavior through implementation of one or more AI/ML training procedures. The AI/ML training procedures may comprise developing a machine-learned configuration (ML CFG) 625. The ML CFG 625 of an SCB model 620 may comprise and/or define aspects of the architecture, structure, implementation, and/or configuration of respective AI/ML components of the SCB model 620. By way of non-limiting example, an SCB model 620 may comprise an ANN and the ML CFG 625 may comprise hyperparameters configured to define one or more of: the architecture of the ANN, the structure of the ANN, the configuration of respective layers of the ANN (e.g., the configuration of an input layer, intermediate layer(s), output layer and so on), the types of layers included in the ANN (e.g., convolutional layers, linear layers, and/or the like), the quantity of nodes included in respective layers of the ANN, interconnections between nodes of respective layers of the ANN (e.g., fully connected, non-fully connected, sparsely connected, or the like), activation functions implemented by nodes of respective layers of the ANN, regularization strength, neuron dropout rate, weights learned for respective nodes, learned activation weights, and/or the like.

In some implementations, SC AI/ML module 720 may be configured to learn and/or refine aspects of the ML CFG 625A-N of one or more SCB models 620A-N. Alternatively, or in addition, one or more of the SCB models 620A-N may comprise, embody, and/or be configured in accordance with an ML CFG 625A-N learned in one or more previously implemented AI/ML training procedures and/or AI/ML training procedures implemented by another system or device. For example, one or more of the SCB models 620A-N may be instantiated, configured, and/or implemented in accordance with ML CFG 625A-N retrieved from DSR resources of the apparatus 102. In some implementations, aspects of one or more of the SCB models 620A-N may be programmable, e.g., may be implemented in software, programmable hardware, or the like. Programmable and/or software aspects of the SCB model(s) 620A-N (if any) may be instantiated and/or configured in accordance with corresponding ML CFG 625A-N. Alternatively, or in addition, aspects of one or more of the SCB model(s) 620A-N may be non-programmable, e.g., may be implemented in read only memory, hardware components (e.g., an IC, ASIC, or other hardware), or the like. Non-programmable aspects of the SCB model(s) 620A-N (if any) may be implemented in accordance with corresponding ML CFG 625A-N, e.g., aspects of the ML CFG 625A-N may be hardwired into the design and/or implementation of one or more hardware components of one or more of the SCB model(s) 620A-N.

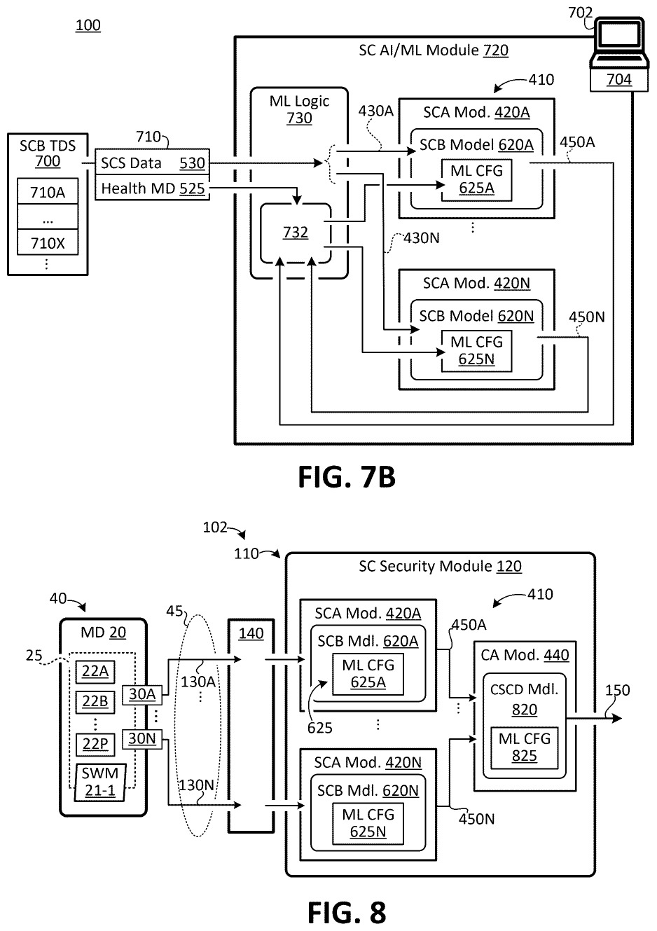

FIG. 7A is a schematic block diagram illustrating an example of SC AI/ML module 720 configured to, inter alia, learn aspects of a CSCA module 410. More specifically, the SC AI/ML module 720 may be configured to learn an ML CFG 625-i adapted to configure an SCB model 620-i of the CSCA module 410 to accurately characterize SC behavior of a specified SC 30-i of an MD 20, e.g., an MD 20 of a device type 25 and/or configuration. In other words, the SCB model 620-i may be trained to generate SC health metrics 450-i in response to SCM data 130-i that accurately indicate the degree to which behavior of the SC 30-i is indicative of a threat and/or anomaly, e.g., accurately characterize operating conditions associated with the behavior exhibited by the SC 30-i.

Aspects of the SC AI/ML module 720 may be implemented and/or embodied by computing resources 704 of an apparatus 702. For example, aspects of the SC AI/ML module 720 may be implemented and/or embodied by computing resources 104 of the apparatus 102 illustrated in FIG. 1.

As illustrated in FIG. 7A, the SC AI/ML module 720 may comprise and/or be coupled to ML logic 730, which may be configured to manage AI/ML training procedures, e.g., manage procedures to learn the SC ML CFG 625, as disclosed herein. The ML logic 730 may learn the ML CFG 625-i by use an SC behavior training dataset (SCB TDS) 700. The SCB TDS 700 may comprise information pertaining to the SC behavior of a device type 25 and/or DCMD 515 (e.g., SWM 21 implemented by the MD 20). The SCM TDS 700 may comprise entries 710, e.g., may comprise X entries 710A-X. The entries 710 may comprise SCS data 530 characteristic of specified operating conditions and health MD 525 configured to identify the specified operating conditions, e.g., may comprise and/or be derived from SCB profiles 530, as disclosed herein. The health MD 525 of the entries 710 may, for example, comprise semantic labels, SC health metrics 450, and/or the like, as disclosed herein. In other words, entries 710 of the SCB TDS 700 may comprise a ground truth (GT) ML dataset; entries 710 of the SCB TDS 700 may comprise SCS data 530 corresponding to behavior of one more of SC 30A-N that has been accurately labeled with health MD 525 (e.g., labeled with information pertaining to the operating conditions characterized by the SCS data 530).

In some implementations, the ML logic 730 may be configured to train the SCB model 620-i to learn SC behavior characteristic of nominal, non-anomalous operating conditions. The SCB TDS 700 may, for example, comprise entries 710A-X comprising SC signatures 430-i associated with “nominal” health MD 525 as illustrated in, e.g., FIG. 5B. In other words, the SCB model 620-i may be configured to generate SC health metrics 450-i that indicate a degree to which behavior of the SC 30-i corresponds to “nominal” operating conditions. Alternatively, or in addition, the ML logic 730 may be configured to train the SCB model 620-i to learn SC behavior characteristic of anomalous operating conditions. The SCB TDS 700 may, for example, comprise entries 710A-X comprising SC signatures 430-i associated with “Anomalous” health MD 525 as illustrated in, e.g., FIG. 5C. In other words, the SCB model 620-i may be configured to generate SC health metrics 450-i that indicate a degree to which behavior of the SC 30-i corresponds to “anomalous” operating conditions.

The disclosure is not limited in this regard, however, and could be adapted to train SCB models 620 to learn any suitable SC behavior(s). For example, the ML logic 730 may be configured to train the SCB model 620-i to learn SC behavior characteristic of nominal specified types of anomalous operating conditions, such as specific types of threats, attacks, cyber-attacks, physical-attacks, network attacks, compromise conditions, failure conditions, and/or the like. The SCB TDS 700 may, for example, comprise entries 710A-X comprising SC signatures 430-i characteristic of respective operating conditions as illustrated in, inter alia, FIG. 5E, e.g., may comprise SCS data 530 associated with “Nominal” health MD 525 as well as SCS data 530 associated with respective anomaly conditions such as “Anomaly A” through “Anomaly F.” The SC health metrics 450-i generated by the SCB model 620-i in response to SCM data 130-i may be configured to indicate a degree to which the SCM data 130-i are indicative of a particular anomaly type (and/or nominal, non-anomalous operation).

The ML logic 730 may be configured to implement AI/ML training iterations. As disclosed herein, an AI/ML training iteration may comprise, inter alia: a) retrieving an entry 710 from the SCB TDS 700, b) configuring the SCB model 620-i to generate SC health metrics 450-i in response to SC signatures 430-i of the SCS data 530 comprising the entry 710, c) comparing the SC health metrics 450-i generated by the SCB model 620-i to the health MD 525 of the entry 710, e.g., by use of ML evaluation logic 732, and d) updating the SCB model 620-i (and/or ML CFG 625) based on the comparing, e.g., updating based on, inter alia, error between the SC health metrics 450 produced by the SCB model 620 and the known, health MD 525 associated with the entry 710. In other words, the evaluation logic 732 may be configured to determine a degree to which the SC health metrics 450-i generated by the SCB model 620-i correspond to the corresponding GT health MD 525. The evaluation logic 732 may, for example, be configured to determine an error, distance, and/or other measure of deviation between the SC health metrics 450-i and health MD 525. The updates determined by the ML logic 730 may be configured to, inter alia, reduce deviation between the SC health metrics 450-i and known health MD 525. The AI/ML training iterations may, therefore, be configured to train the SCB model 620 to generate SC health metrics 450 in response to SCM data 130 acquired from an MD 20 that accurately characterizes the operating conditions of the MD 20 based on the SC behavior exhibited by SC 30 of the MD 20, e.g., accurately indicates a degree to which the SCM data 130 is indicative of a threat and/or anomaly.

In some implementations, the SC AI/ML module 720 may be configured to train SCB models 620A-N independently. For example, the SC AI/ML module 720 may be configured to learn an ML CFG 625A configured to generate SC health metrics 450A in response to SCM data 130A that accurately reflect device operating conditions characteristic of such SCM data 130A (e.g., indicate a degree to which the behavior exhibited by SC 30A is indicative of “nominal” or “anomalous” operating conditions) in first AI/ML procedures; learn an ML CFG 625N configured to generate SC health metrics 450N in response to SCM data 130N that accurately reflect device operating conditions characteristic of such SCM data 130N (e.g., indicate a degree to which the behavior exhibited by SC 30N is indicative of “nominal” or “anomalous” operating conditions) in second AI/ML procedures different from the first AI/ML procedures; and so on. Alternatively, or in addition, the SC AI/ML module 720 may be configured to learn SCB models 620 for one or more SC 30 concurrently and/or in parallel.

FIG. 7B is a schematic bloc diagram illustrating another example of an SC AI/ML module 720 configured to learn SC behavior of one or more SC 30 of an MD 20. In the FIG. 7B example, ML logic 730 of the SC AI/ML module 720 may be configured to learn SC behavior of a plurality of SC 30 concurrently and/or in parallel, e.g., may be configured to train SCB models 620A-N of an CSCA module 410 in parallel.

The ML logic 730 may be configured to perform AI/ML training iterations, comprising a) retrieving an entry 710 from the SCB TDS 700, b) configuring SCA models 420A-N to generate SC health metrics 450A-N in response to the SCS data 530 of the entry 710, e.g., in response to SC signatures 430A-N, respectively, c) comparing the SC health metrics 450A-N generated by the SCB models 620A-N to the health MD 525 of the entry 710, e.g., by use of ML evaluation logic 732, and d) updating the SCB models 620A-N (and/or ML CFG 625A-N thereof) based on the comparing, e.g., updating based on, inter alia, error between the SC health metrics 450A-N produced by the SCB models 620A-N and the known, health MD 525 associated with the entry 710.

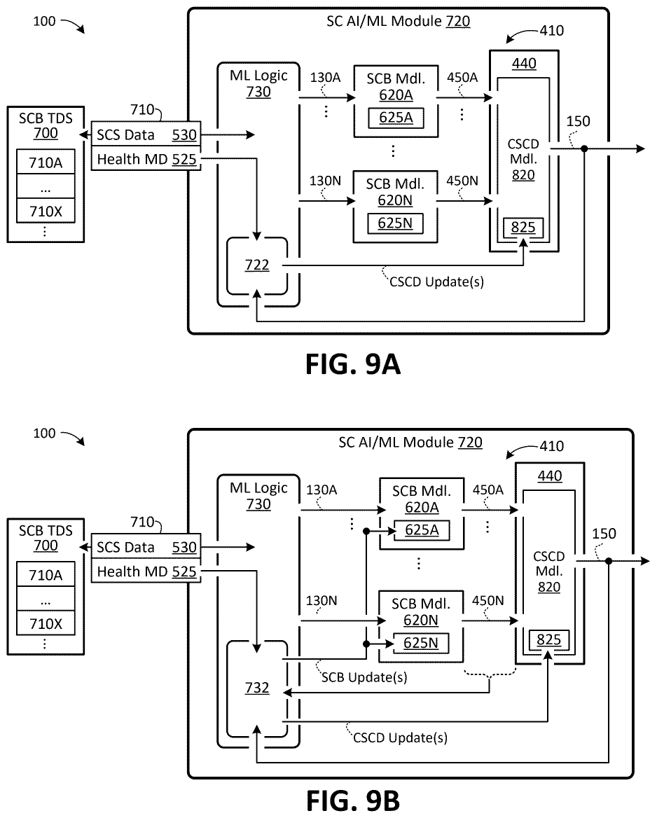

FIG. 8 is a schematic block diagram illustrating another example of a CSCA module 410. In the FIG. 8 example, the CSCA module 410 may comprise SCB models 620, which may be trained to generate SC health metrics 450A-N in response to SCM data 130A-N acquired from respective SC 30A-N of the MD 20. As disclosed herein, the SC health metrics 450A-N may be configured to indicate a degree to which the behavior exhibited by respective SC 30A-N corresponds to SC behavior characteristic of “nominal” operating conditions and/or one or more “anomalous” operating conditions.

The CA module 440 may be configured to derive health metrics 150 for the MD 20 from the SC health metrics 450A-N determined for respective SC 30A-N. In some implementations, the CA module 440 may be configured to assess the SC health metrics 450A-N in accordance with CSCA logic 442. Alternatively, in the FIG. 8 example, the CSCA module may comprise and/or be coupled to a complimentary SC discriminator (CSCD) model 820. The CSCD model 820 may comprise AI/ML components configured to generate combined and/or complimentary health metrics 150 in response to the SC health metrics 450A-N generated by respective SCB models 620A-N. For example, the CSCD model 820 may be trained to generate health metrics 150 that quantify a degree to which the combined behavior of SC 30A-N is indicative of a threat and/or anomaly. The CSCD model 820 may be configured in accordance with an ML CFG 825, which may be learned through AI/ML training procedures, as disclosed in further detail herein.

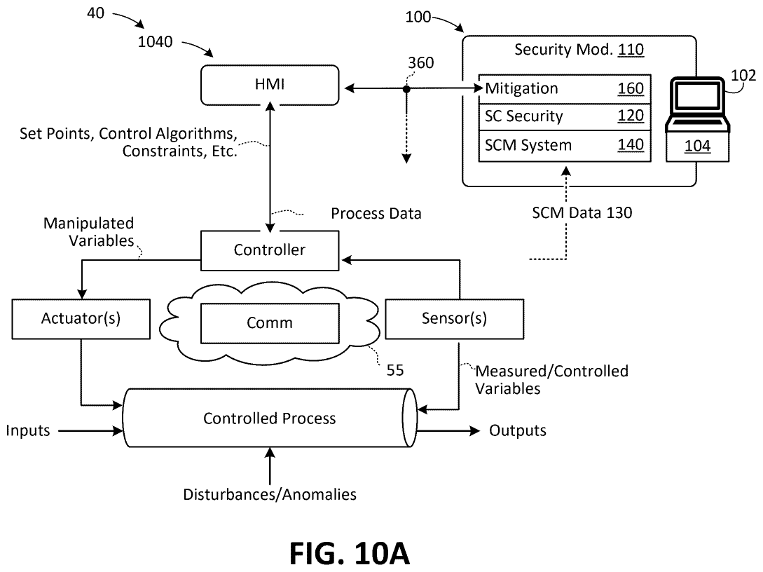

FIG. 9A is a schematic block diagram illustrating another example of an SC AI/ML module 720. In the FIG. 9A example, the SC AI/ML module 720 may be configured to, inter alia, learn an ML CFG 825 adapted to configure the CSCD model 820 learn health metrics 150 for behaviors exhibited by respective SC 30A-N of the MD 20. More specifically, the CSCD model 820 may be trained to translate the SC health metrics 450A-N determined for respective SC 30A-N to health metrics 150 that accurately characterize operating conditions of the MD 20.

As illustrated in FIG. 9A, ML logic 730 of the SC AI/ML module 720 may be configured to implement AI/ML training iterations configured, inter alia, to develop and/or refine the ML CFG 825 of the CSCD model 820. AI/ML training iterations may comprise: a) retrieving an entry 710 from the SCB TDS 700, b) configuring the SCB models 620A-N to generate SC health metrics 450A-N for respective SC 30A-N in response to SCS data 530 of the entry 710, e.g., generate SC health metrics 450A-N in response to respective SC signatures 430A-N, c) configuring the CSCD model 820 to generate health metrics 150 in response to the SC health metrics 450A-N, d) comparing the health metrics 150 to the health MD 525 of the entry 710, e.g., by use of ML evaluation logic 732, and d) updating the CSCD model 820 (and/or ML CFG 825) based on the comparing, e.g., updating based on, inter alia, error between the health metrics 150 produced by the CSCD model 820 and the known, health MD 525 associated with the entry 710. In other words, the evaluation logic 732 may be configured to quantify deviation between the health metrics 150 generated by the CSCD model 820 and corresponding GT health MD 525. The evaluation logic 732 may, for example, be configured to determine an error, distance, and/or other measure of deviation between the health metrics 150 and health MD 525. The updates determined by the ML logic 730 may be configured to, inter alia, reduce deviation between the health metrics 150 and known health MD 525. The AI/ML training iterations may, therefore, be configured to train the CSCD model 820 to generate health metrics 150 in response to SC health metrics 450A-N that accurately characterize the operating conditions of the MD 20 based on the SC behavior exhibited by SC 30A-N of the MD 20, e.g., accurately indicates a degree to which the SCM data 130 is indicative of a threat and/or anomaly.

In the FIG. 9A example, the SC AI/ML module 720 may be configured to learn the CSCD model 820 using trained SCB models 620A-N. In other words, the SCD models 620A-N may be configured in accordance with ML CFG 625A-N learned, developed, and/or refined in one or more previous AI/ML training operations. The disclosure is not limited in this regard, however, and could be adapted to train the CSCD model 820 and one or more SCB models 620A-N concurrently and/or in parallel.

FIG. 9B is a schematic block diagram illustrating another example of an SC AI/ML module 720. In the FIG. 9B example, the SC AI/ML module 720 may be configured to, inter alia, learn one or more SCB models 620A-N in parallel and/or concurrently with learning an ML CFG 825. In the FIG. 9B implementation, the AI/ML training iterations performed by the ML logic 730 may comprise, inter alia: a) retrieving an entry 710 from the SCB TDS 700, b) configuring the SCB models 620A-N to generate SC health metrics 450A-N for respective SC 30A-N in response to SC signatures 430A-N of the entry 710, c) configuring the CSCD model 820 to generate health metrics 150 in response to the SC health metrics 450A-N generated by the SCB models 620A-N, d) comparing the SC health metrics 450A-N generated by the SCB models 620A-N to health MD 525 associated with the SC signatures 430A-N, e) updating the SCB models 620A-N (and/or corresponding ML CFG 625A-N) based on the comparing, f) comparing the health metrics 150 generated by the CSCD model 820 to the health MD 525 of the entry 710, g) updating the CSCD model 820 (and/or ML CFG 825) based on the comparing. Accordingly, in the FIG. 9B example, the evaluation logic 732 may be configured to determine a degree to which the SC health metrics 450A-N generated by the SCB models 620A-N accurately characterize the behavior of respective SC 30A-N and/or update the SCB models 620A-N accordingly. The evaluation logic 732 may be further configured to determine a degree to which the health metrics 150 generated by the CSCD model 820 accurately characterize the operating conditions of the MD 20 and/or update the CSCD model 820 accordingly.

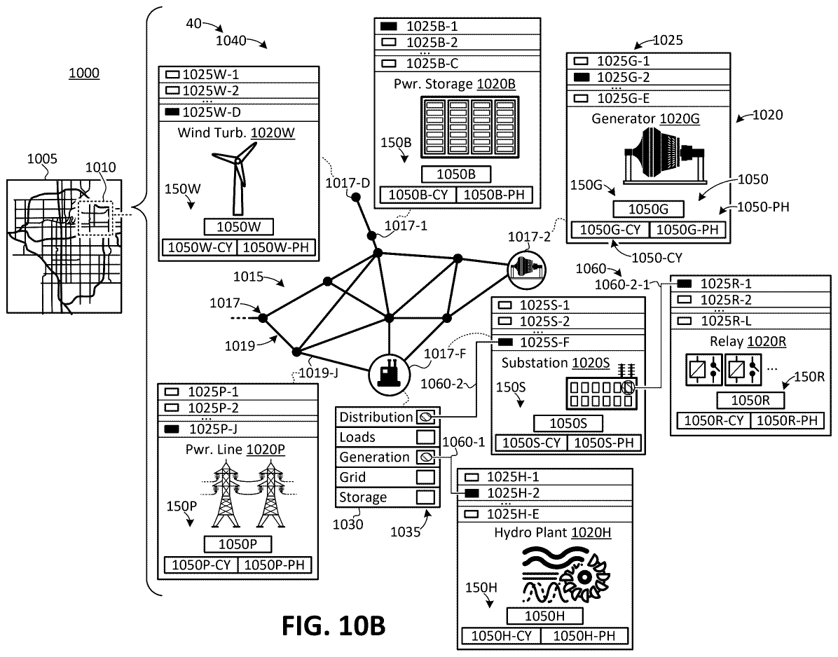

As disclosed herein, the SCS module 120 may be configured to monitor any suitable type of MD 20 comprising any suitable SC 30. In some implementations, the SCS module 120 may be configured to monitor a cyber-physical system, such as a control system or the like. FIG. 10A is a schematic block diagram of a system 100 configured to monitor a control system 1040. The control system 1040 may comprise sensors configured to acquire information pertaining to a controlled process (e.g., acquire measured and/or controlled variables), control components configured to determine control actions in response to sensor data (e.g., a controller), and actuators configured to implement the determined control actions. The control system 1040 may also include communication devices configured to, inter alia, communicatively and/or operatively couple elements of the control system. The communication devices may, for example, implement aspects of an electronic communication network 55. The control system 1040 may further comprise HMI components, which may be used to configure aspects of the control system 1040, such as set points, control algorithms, parameter constraint, and so on. The controller may be further configured to maintain control variables within specified set points, constraints, and/or the like in the presence of disturbances or anomalies.

The security module 110 may be configured to monitor control system devices, which may include, but are not limited to: sensors, controllers, actuators, and so on. The SCM system 140 may be configured to acquire SCM data 130 from one or more MD 20 within the control system 1040, the SCS module 120 may be configured to determine health metrics 150 for respective MD 20, which may indicate a degree to which SC behavior of the MD 20 is indicative of nominal, non-anomalous behavior, and the mitigation module 160 may be configured to determine and/or implement mitigation actions 360 based, at least in part, on the health metrics 150. The security module 110 may, therefore, detect anomalies and/or threats pertaining to MD 20 without the need for deploying security means on the MD 20 themselves. The SCS module 120 may not require any modifications to the MD 20 monitored thereby. This may be particularly advantageous in MS 40 comprising MD 20 having limited processing resources (if any), such as sensor and actuator devices of the control system 1040 illustrated in the FIG. 10A example.

FIG. 10B illustrates an example of a graphical user interface (GUI) 1000 for displaying information pertaining to an MS 40 such as a control system 1040 or the like. The GUI 1000 may comprise and/or be implemented by HMI components, as illustrated in FIG. 10A. The GUI may comprise a map element 1005, which may comprise a graphical representation of the MS 40. For example, the map element 1005 may correspond to a geographical location of components of the MS 40. In the FIG. 10B example, the MS 40 may comprise a power generation and distribution system (e.g., a power grid) and the map element 1005 may display geographical locations of components comprising the power grid, e.g., may display locations of power generators (e.g., wind turbines, hydroelectric generators, and so on), power lines, power storage systems, substations, substation components (e.g., relay devices), and so on.

A user may interact with the map element 1005 to, inter alia, select a portion of the MS 40 to display within the GUI 1000. In the FIG. 10B example, the map element 1005 may comprise a selection element 1010 configured to enable a user to select a geographical area. In response to selection of a geographical area within the map element 1005, the GUI 1000 may be updated to display information pertaining to the MS 40 located within the selected geographical area. The map element 1005 may comprise other user interface elements. For example, the map element 1005 may be configured to display alert indicators to identify components of the MS 40 (e.g., MD 20) having health metrics 150 indicative of anomalous operation, or the like.

In the FIG. 10B example, the GUI 1000 may be configured to display components of the MS 40 located within the geographic region defined by the selection element 1010. The GUI 1000 may comprise a topological view (TV) element 1015. The TV element 1015 may be configured to, in ter alia, display information pertaining to the topology of the selected portion of the MS 40, e.g., may be configured to display topological information pertaining to the components of the MS 40 located within the geographic region corresponding to the selection element 1010. The GUI 1000 may be configured to represent components of the MS 40 as nodes 1017 within the TV element 1015 and represent connections between components using edges 1019.

In the FIG. 10B example, the TV element 1015 displays a topology of the portion of the MS 40 comprising one or more power generation components (e.g., one or more generators, wind turbines, hydroelectric generators, and/or the like), power distribution components (e.g., one or more substations, power lines, and/or the like), power storage components (e.g., one or more battery storage components), and so on. The TV element 1015 may further comprise information pertaining to other components, such as loads on the power distribution system and/or the like (not shown in FIG. 10B to avoid obscuring details of the illustrated examples).

The GUI 1000 may further comprise component elements 1020, which may comprise information pertaining to respective components of the MS 40. As used herein, a component of an MS 40 may comprise and/or refer to a collection of one or more MD 20. The component elements 1020 may be configured to display information pertaining to particular types of components, e.g., generators, substation, relays, and so on. For example, a component element 1020 may comprise one or more component selection (CS) elements 1025, each corresponding to a respective element of a particular type. In the FIG. 10B example, the GUI 1000 may include, but is not limited to: a generator component (GC) element 1020G configured to display information pertaining to one or more generator components of the MS 40 (e.g., the GC element 1020G may be configured to display information pertaining to E generator components per CS elements 1025G-1 through 1025G-E); a power-storage component (PSC) element 1020B configured to display information pertaining to one or more power-storage components of the MS 40 (e.g., the PSC element 1020B may be configured to display information pertaining to C PS components per CS elements 1025B-1 through 1025B-C); a wind-turbine component (WTC) element 1020W configured to display information pertaining to one or more wind-turbine components of the MS 40 (e.g., the WTC element may be configured to display information pertaining to D wind-turbine components per CS elements 1025W-1 through 1025-D); a hydroelectric generator component (HGC) element 1020H configured to display information pertaining to one or more hydroelectric generator components (e.g., the HGC element 1020H may be configured to display information pertaining to E hydroelectric generator components per CS elements 1025H-1 through 1025H-E); a substation component (SC) element 1025S configured to display information pertaining to one or more substation components of the MS 40 (e.g., the SC element 1020S may be configured to display information pertaining to F substation components per CS elements 1025S-1 through 1025S-F); a relay component (RC) element 1020R configured to display information pertaining to one or more relay elements of the MS 40 (e.g., the RC element 1020 may be configured to display information pertaining to L relay components per CS elements 1025R-1 through 1025R-L); a power line component (PLC) element 1020P configured to display information pertaining to one or more power line components of the MS 40 (e.g., the PLC element 1020P may be configured to display information pertaining to J power line components per CS elements 1025P-1 through 1025P-J); and so on.

As disclosed herein, the component elements 1020 of the GUI 1000 may be configured to display information pertaining to respective types of components, e.g., generators, power storage systems, substations, power lines, and so on. In other words, the component elements 1020 may be configured to group components of the MS 40 by type. For example, the GC element 1020G may be configured to selectively display information pertaining to a selected one of E generators of the MS 40, e.g., per selection of one of the G CS elements 1025G-1 through 1025-E and/or a node 1017 of the TV element 1015. In the FIG. 10B example, the GC element 1020G may be configured to display information pertaining to the generator component corresponding to CS element 1025G-2 (which may correspond to node 1017-2 of the TV element 1015), the PSC element 1020B may be configured to display information pertaining to the battery power-storage component corresponding to CS element 1025B-1 (which may correspond to node 1017-1 of the TV element 1015), the WTC element 1020W may be configured to display information pertaining to the wind turbine component corresponding to the CS element 1025W-D (which may correspond to node 1017-D of the TV element 1015), the HGC element 1020H may be configured to display information pertaining to the hydroelectric generator component corresponding to CS element 1025H-2, the SC element 1025S may be configured to display information pertaining to the substation corresponding to the CS element 1025S-F (which may correspond to node 1017-F of the TV element 1015), the RC element 1020R may be configured to display information pertaining to the relay component corresponding to CS element 1025R-1, the PLC element 1020P may be configured to display information pertaining to the power line component corresponding to CS element 1025P-J (which may correspond to edge 1019-J of the TV element 1015), and so on.

The component elements 1020 may further comprise health elements 1050, which may be configured to, inter alia, display information pertaining to the health of the components represented thereby. The health elements 1050 may comprise and/or be derived from health metrics 150 generated by the SCS module 120, as disclosed herein. For example, the health elements 1050 of a component element 1020 may be configured to display information comprising and/or derived from the health metrics 150 determined for one or more MD 20 comprising the corresponding component. Accordingly, the information displayed by a health element 1050 may comprise and/or be derived from health metrics 150 determined for one or more MD 20 based on, inter alia, the behaviors exhibited by a plurality of SC 30 of the one or more MD 20.

As illustrated in the FIG. 10B example, in some implementations, a component element 1020 may comprise a plurality of health elements 1050. The health elements 1050 may be configured to display information pertaining to the health of respective aspects or subsets of the component. For example, the health elements 1050 may be configured to indicate the health of selected MD 20 comprising the component, respective groups or subsets of the MD 20 comprising the component, and/or the like. The health elements 1050 may be configured to display information generated for respective types of MD 20. By way of non-limiting example, the health elements 1050 may comprise, inter alia, a cyber-health element 1050-CY and a physical health element 1050-PH.

As used herein, a cyber-health element 1050-CY may comprise and/or refer to a health element 1050 that is configured to display information pertaining to the cyber health of a component and/or one or more MD 20 thereof. As used herein, cyber health may comprise and/or refer to the health of cyber-related functionality, e.g., network communication functionality. For example, the cyber health of a component may comprise and/or be derived from health metrics 150 determined for cyber-related MD 20 of the component, the behavior of cyber-related SC 30 of one or more MD 20 comprising the component (e.g., the behavior of the network SC 30-NW of one or more MD 20), and/or the like. As used herein, a cyber-related MD 20 of a component may comprise and/or refer to an MD 20 configured to utilize, implement and/or embody cyber functionality of the component such as a network interface, router, switch, firewall, terminal, network-connected MD 20, IED, or the like.

As used herein, a physical-health element 1050-PH may comprise and/or refer to a health element 1050 that is configured to display information pertaining to the physical health of a component and/or one or more MD 20 thereof. As used herein, physical health may comprise and/or refer to the health of physical-related functionality of the component. For example, the physical health of a component may comprise and/or be derived from health metrics 150 determined for physical-related MD 20 of the component, the behavior of physical-related SC 30 of one or more MD 20 comprising the component, and/or the like. As used herein, a physical-related MD 20 of a component may comprise and/or refer to an MD 20 configured to utilize, implement and/or embody physical functionality of the component such as an actuator, motor, turbine, transformer, or the like.

The component elements 1020 of the GUI 1000 may comprise any suitable health elements 1050 configured to display any suitable health-related information. In the FIG. 10B example, the GC element 1020G may comprise health element(s) 1050G comprising information derived from health metrics 150G determined for one or more of the MD 20 comprising the generator corresponding to CS element 1025G-2 (e.g., MD 20 corresponding to a turbine, armature, lubrication components, and/or the like), which may include a cyber-health element 1050G-CY configured to display information pertaining to the cyber health of the generator and a physical-health element 1050G-PH configured to display information pertaining to the physical health of the generator, and so on; the PSC element 1020B may comprise health element(s) 1050B comprising information derived from health metrics 150B determined for one or more of the MD 20 comprising the power storage component corresponding to CS element 1025B-2 (e.g., MD 20 corresponding to battery storage system or the like), and which may include a cyber-health element 1050B-CY, a physical-health element 1050B-PH, and so on; the WTC element 1020W may comprise health element(s) 1050W comprising information derived from health metrics 150B determined for one or more of the MD 20 comprising the wind turbine component corresponding to CS element 1025W-D (e.g., MD 20 corresponding to a designated wind turbine or wind turbine farm), and which may include a cyber-health element 1050W-CY, a physical-health element 1050W-PH, and so on; the HGC element 1020H may comprise health element(s) 1050H comprising information derived from health metrics 150H determined for one or more of the MD 20 comprising the hydroelectric generator corresponding to CS element 1025G-2 (e.g., MD 20 corresponding to a hydroelectric turbine, rotor, stator, and/or the like), and which may include a cyber-health element 1050H-CY, a physical-health element 1050H-PH, and so on; the SC element 1020H may comprise health element(s) 1050S comprising information derived from health metrics 150H determined for one or more of the MD 20 comprising the substation corresponding to CS element 1025S-F (e.g., MD 20 corresponding to a substation relay, bus, transformer, and/or the like), and which may include a cyber-health element 1050S-CY, a physical-health element 1050S-PH, and so on; the RC element 1020R may comprise health element(s) 1050R comprising information derived from health metrics 150R determined for one or more of the MD 20 comprising the relay corresponding to CS element 1025R-1, and which may include a cyber-health element 1050R-CY, a physical-health element 1050R-PH, and so on; the PLC element 1020P may comprise health element(s) 1050P comprising information derived from health metrics 150P determined for one or more of the MD 20 comprising the power line component corresponding to CS element 1025P-J (e.g., MD 20 corresponding to conductors, transformers, and/or the like), and which may include a cyber-health element 1050P-CY, a physical-health element 1050P-PH, and so on.

In some implementations the GUI 1000 may further comprise a system functionality (SF) element 1030, which may be configured to display information pertaining specified functional aspects of the MS 40. In the FIG. 10B example, the MS 40 may comprise a power grid and, as such, the SF element 1030 may be configured to display information pertaining to functional aspects of the power grid, such as distribution, loads on the power grid, power generation functionality of the power grid, power distribution functionality (e.g., grid functionality), power storage functionality, and so on. The SF element 1030 may be configured to associate component elements 1020 of the GUI 1000 with corresponding functional aspects or categories. For example, SF element 1030 may: associate the distribution functional category with component elements 1020 configured to represent substations, relays, and/or other components configured to implement and/or embody power distribution functionality of the MS 40 (e.g., the SC element 1020S, RC element 1020R, and so on); associate the load functional category with component elements 1020 configured to represent loads on the power grid (not shown in FIG. 10B to avoid obscuring details of the illustrated examples); associate the generation functional category with component elements 1020 that represent power-generating components of the MS 40 (e.g., the GC element 1020G, WTC element 1020W, HGC element 1020H, and so on); associate the grid functional category with components pertaining to grid functionality of the MS 40 (e.g., the PLC element 1020P); associate the storage functional category with components pertaining to power storage functionality of the MS 40 (e.g., the PLC component 1020B); and so on.

In some implementations, the GUI 1000 may be capable of providing alert elements 1060. As used herein, an alert element 1060 may comprise and or refer to a GUI element configured to provide an alert, warning, or other notification pertaining to the health of the MS 40 and/or one or more MD 20 thereof. The GUI 1000 may be configured to display alert elements 1060 in response to mitigation actions 160 implemented by the security module 110. The mitigation module 160 may trigger display of an alert element 1060 based on any suitable criteria, including, but not limited to: health metrics 150 indicative of anomalous operating conditions, health metrics 150 trending towards indication of an anomalous condition (e.g., a warning), SC health metrics 450 indicative of anomalous operating conditions, SC health metrics 450 trending towards indication of an anomaly, and/or the like. An alert element 1060 may be configured to identify the source of the anomalous health metrics 150. For example, an alert element 1060 may be associated with one or more functional aspects or categories of the MS 40, component(s) of the MS 40, one or more MD 20, health metrics 150 of one or more MD 20, SC health metrics 450 of one or more MD 20, and/or the like.

In the FIG. 10B example, the GUI 1000 includes an alert element 1060-1, which may be configured to indicate a warning pertaining to the power generation functionality of the MS 40. The alert element 1060-1 may be further configured to identify the hydroelectric generator corresponding to CS element 1025H-2 as the source of the health warning. The alert element 1060-1 may be further configured to identify the MD 20 associated with the health warning, e.g., may indicate that the source of the health warning is a lubrication MD 20 of the hydroelectric generator. The alert element 1060-1 may be further configured to identify the one or more MD 20 (and/or SC health metrics 450) that triggered display of the alert element 1060-1.

The GUI 1000 illustrated in FIG. 10B further includes alert element 1060-2 pertaining to the power distribution functionality of the MS 40. The alert element 1060-2 may identify the substation corresponding to CS element 1025S-F as the source of the alert notification. The alert element 1060-2 may be further configured to identify the source of the alert within the substation. In the FIG. 10B example, the alert element 1060-2 may be triggered by an anomaly pertaining to a relay component of the substation. The alert element 1060-2 may comprise an alert element 1060-2-1, which may be configured to identify the relay corresponding to CS 1025R-1 as the source of the anomaly. For example, the alert element 1060-2-1 may identify the health metrics 150R (and/or health element 1050R) determined to be indicative of anomalous operation of the relay.

FIG. 10C is a schematic block diagram illustrating another example of a system for detecting anomalies pertaining to MD 20 of a control system 1040. In some implementations, the SCS module 120 may be configured to monitor MD 20 of different device types 25 and/or configurations, e.g., MD 20 having different architectures, configured to implement different SWM 21, and so on. As illustrated in the FIG. 10C example, the SCS module 120 may be configured to monitor SC behavior G groups of MD 20, including MD 20AA-AG comprising MD 20 of device type 25A configured to implement SWM 21A, MD 20BA comprising an MD 20 of device type 25B configured to implement SWM 21B, MD 20CA-CE comprising MD 20 of device type 25C configured to implement SWM 21C, MD 20GA-GJ comprising MD 20 of device type 25G configured to implement SWM 21G, and so on. For example, the MD 20AA-AG may comprise designated type of sensor device, the MD 20BA may comprise a control device (e.g., a particular type of controller), the MD 20CA-CE may comprise communication devices, and the MD 20GA-GJ may comprise a particular type of actuator device.

The SCS module 120 may comprise CSCA modules 410 configured to assess the SC 30 of respective devices types 25A-G. As illustrated in FIG. 10C, the SCS module 120 may comprise a CSCA module 410A configured to characterize SC behavior of device type 25A configured in accordance with SWM 21A, a CSCA module 410B configured to characterize SC behavior of device type 25B configured in accordance with SWM 21B, a CSCA module 410C configured to characterize SC behavior of device type 25C configured in accordance with SWM 21C, a CSCA module 410G configured to characterize SC behavior of device type 25G configured in accordance with SWM 21G, and so on.

The CSCA modules 410 may comprise respective SCA modules 420, which may be configured to assess the behavior of respective SC 30 of each device type 25. The CSCA module 410A may comprise SCA modules 420 configured to assess the behavior of specified SC 30 of device type 25A (configured per SWM 21A), the CSCA module 410B may comprise SCA modules 420 configured to assess the behavior of specified SC 30 of device type 25B (configured per SWM 21B), the CSCA module 410C may comprise SCA modules 420 configured to assess the behavior of specified SC 30 of device type 25C (configured per SWM 21C), the CSCA module 410G may comprise SCA modules 420 configured to assess the behavior of specified SC 30 of device type 25G (configured per SWM 21G), and so on.

In some implementations, one or more of the CSCA modules 410A-G may comprise SCA modules 420 configured to compare the behavior exhibited by respective SC 30 to baseline SC behaviors, e.g., per SC signatures 430 determined for the device types 25A-G and/or SWM 21A-G as described above in conjunction with, inter alia, FIG. 4. Alternatively, or in addition, one or more of the CSCA modules 410A-G may comprise AI/ML components trained to characterize SC behavior. The CSCA modules 410A-G may comprise respective SCB models 620 trained to characterize the SC behavior of device types 25A-G (configured per SWM 21A-G), respectively. For example, the CSCA modules 410A-G may comprise SCB models 620 configured in accordance with ML CFG 625 learned through one or more AI/ML training procedures.

The SCS module 120 may comprise and/or be coupled to an SCM system 140, which may be configured to acquire SCM data 130 from MD 20. The CSCA modules 410A-G may utilize the acquired SCM data 130 to, inter alia, assess the behavior of respective SC 30 of the MD 20 and generate corresponding health metrics 150. The mitigation module 160 may evaluate the health metrics 150 determined for respective MD 20 and determine and/or implement one or more mitigation actions 360 based, at least in part, on the health metrics.

In the FIG. 10C example, the SCM system 140 may be configured to acquire SCM data 130AA-AG from MD 20AA-AG of device type 25A, acquire SCM data 130BA from MD 20BA of device type 25B, acquire SCM data 130CA-CE from MD 20CA-CE of device type 25C, acquire SCM data 130GA-GJ from MD 20GA-GJ of device type 25G, and so on. The CSCA module 410A may be configured to generate health metrics 150AA-AG configured to characterize the SC behavior of MD 20AA-AG based, at least in part, on the SCM data 130AA-AG, the CSCA module 410B may be configured to generate health metrics 150BA configured to characterize the SC behavior of MD 20BA based, at least in part, on the SCM data 130BA, the CSCA module 410C may be configured to generate health metrics 150CA-CE configured to characterize the SC behavior of MD 20CA-CE based, at least in part, on the SCM data 130CA-CE, the CSCA module 410G may be configured to generate health metrics 150GA-GJ configured to characterize the SC behavior of MD 20GA-GJ based, at least in part, on the SCM data 130GA-GJ, and so on.

The mitigation module 160 may evaluate the health metrics 155AA-GJ may evaluate the health metrics 150AA-GJ determined for respective MD 20AA-GJ and may determine and/or implement one or more mitigation actions 360 based on the evaluation. For example, the mitigation module 160 may be configured to implement mitigation actions 360 in response to determining that one or more MD 20AA-GJ is exhibiting anomalous SC behavior, e.g., is exhibiting SC behavior characteristic of anomalous operating conditions, as disclosed herein.

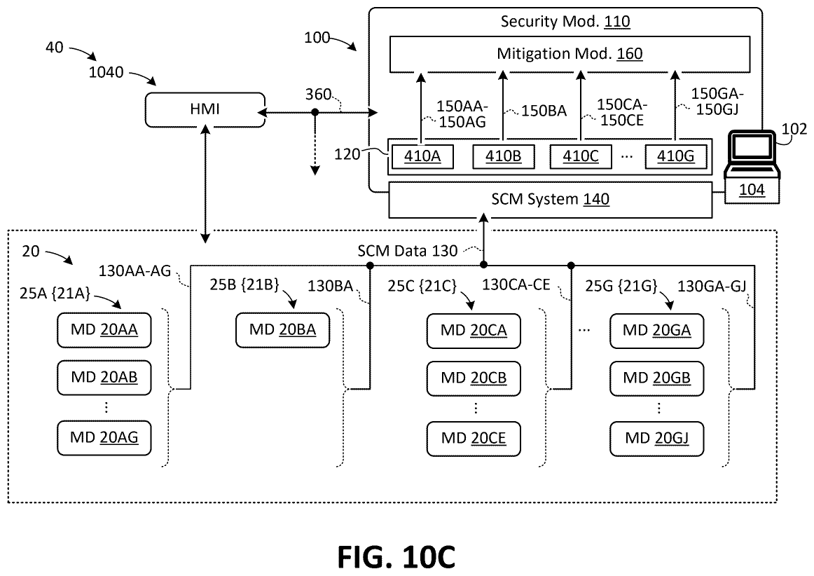

The CSCA modules 410A-G may be configured to assess the behavior of any suitable SC 30 of any suitable MD 20. FIG. 11A is a schematic block diagram illustrating an example of a CSCA module 410 configured to assess the behavior of a plurality of SC 30 of a MD 20-1. In the FIG. 11A example, the MD 20-1 may comprise and/or implement computing resources 1104, which may include, but are not limited to one or more of: processing resources 1104-1, DSR resources (e.g., memory resources 1104-2, NTS resources 1104-3, and so on), DI resources 1104-4, and/or the like. The MD 20-1 may comprise any suitable computing means including, but not limited to: an IED, embedded device, a computing device, a compute module, a compute node, a control module, a controller, a PLC, an I/O module, a cyber module, a communication device, or the like. Aspects of the computing resources 1104 may be embodied by components of the MD 20-1. For example, a processing unit (PU) 1106 of the MD 20-1 may be configured to implement aspects of the processing resources 1104-1 of the MD 20-1 (e.g., the PU 1106 may comprise a processing unit (PU) such as an IC, a CPU, an ALU, a PLD, an FPGA, an ASIC, a SoC, a controller, a PLC, and/or the like), a memory unit (MU) 1108 may be configured to implement aspects of the memory resources 1104-2 of the MD 20 (e.g., the MU 1108 may comprise a cache, memory, memory bus, and/or the like), and so on. As illustrated in FIG. 11A, the MD 20-1 may further comprise a power supply (PS) 1110 configured to power components of the MD 20-1. The PS 1110 may comprise an energy storage device such as a battery. Alternatively, or in addition, the PS 1110 may be configured to interface with an external power source, e.g., the PS 1110 may comprise a power interface, power connector, power converter, and/or the like.

As illustrated in FIG. 11A, the MD 20-1 may comprise and/or be implemented according to a specified computing architecture (e.g., per device type 25-1). The device type 25-1 may comprise and/or define, inter alia, an instruction set architecture (ISA) supported by the MD 20-1. The ISA may comprise and/or define the set of machine-executable instructions (MEI) the MD 20-1 is configured to implement. The ISA may correspond to the architecture of the PU 1106 and/or other processing resources 1104-1 of the MD 20-1. The MD 20-1 may be configured to support any suitable ISA including, but not limited to: a Complex Instruction Set Computer (CISC) architecture, a Reduced Instruction Set Computer (RISC) architecture, an Advanced RISC Machine (ARM) architecture, an SoC architecture, an embedded device architecture, and/or the like. The MD 20-1 may be further configured to implement a SWM 21-1, which may define the settings, configuration, firmware, machine-executable instructions (MEI), and/or other programmable functionality of the MD 20-1.

FIG. 11A further illustrates an example of an SCM system 140 configured to monitor SC 30A-N of the MD 20-1. The SCM system 140 may comprise and/or be coupled to a plurality of SC DAQ modules 240, each configured to acquire SCM data 130 pertaining to a respective SC 30 of the MD 20-1. In the FIG. 11A, the SC DAQ module 240-EM may be configured to acquire SCM data 130-EM pertaining to an SC 30-EM of the MD 20-1. The SC DAQ module 240-EM may be configured to sense any suitable type of EM radiation, e.g., EM signals at any suitable frequency, frequency range, energy, energy range, and/or the like. The SC DAQ module 240-EM may be positioned to monitor EM emitted by the SC 30-EM of the MD 20-1. In some implementations, the SC 30-EM may comprise and/or correspond to EM radiation generated by processing resources 1104-1 of the MD 20-1 such as the PU 1106 and/or the like. The SC DAQ 240-EM may comprise and/or be coupled to any suitable means for sensing, detecting, measuring, observing and/or otherwise monitoring EM radiation including, but not limited to: an EM sensor, a magnetic sensor, a magnetic field sensor, an electromagnetic field (EMF) sensor, an inductive sensor, an induction coil, an antenna, and/or the like.

The SCM data 130-EM acquired by the SC DAQ module 240-EM may comprise any suitable information pertaining to EM signals emanating from the SC 30-EM of the MD 20-1. The SCM data 130-EM may be expressed in any suitable terms and/or in any suitable format. For example, the SCM data 130-EM may be expressed in terms of energy, wavelength, frequency, and/or the like. The SCM 130-EM may be captured over any suitable time and/or monitoring period. For example, the SCM 130-EM may comprise a continuous signal, a discrete signal (e.g., may comprise data points corresponding to a discrete sampling period or frequency), and/or the like. In some implementations, the SCM 130-EM may comprise EM spectra, e.g., may quantify EM radiation energy across a range of wavelengths or frequencies. Alternatively, or in addition, the SCM data 130-EM may be configured to quantify EM radiation energy detected at specified wavelengths or frequencies, e.g., at frequencies corresponding to operating frequencies of computing resources 1104 of the MD 20-1, such as a clock frequency, CPU clock frequency, bus frequency, and/or the like. The SCM data 130-EM may comprise any suitable representation of the behavior exhibited by the SC 30-EM; the SCM 130-EM may comprise one or more of a time domain representation (e.g., EM amplitude over time), frequency domain representation (e.g., EM amplitude over frequency), a spectrogram (e.g., frequency over time), and/or the like.

In the FIG. 11A example, the SCM system 140 may further comprise an SC DAQ module 240-TH configured to, inter alia, monitor a TH SC 30-TH of the MD 20-1. For example, the SC DAQ module 240-TH may be configured to monitor thermodynamic characteristics of the PU 1106 of the MD 20-1. The SC DAQ 240-TH may comprise and/or be coupled to any suitable means for acquiring thermodynamic data including, but not limited to: a temperature sensor, a temperature probe, a thermometer, a thermistor, a negative temperature coefficient (NTC) thermistor, a resistance temperature detector (RTD), a thermocouple, a semiconductor-based sensor, a silicon diode sensor, an electro-optical (EO) radiation sensor, an infrared (IR) sensor, and/or the like. The SC DAQ module 240-TH may be configured to acquire SCM data 130-TH pertaining to a TH SC 30-TH of the MD 20-1, e.g., may be configured to acquire TH SCM 130-TH. The SCM 130-TH may comprise any suitable representation of any suitable thermodynamic characteristic; SCM data 130-TH may include, but are not limited to, temperature values (e.g., values indicating a temperature of the processing unit 206), absolute temperature values, relative temperature values (e.g., values indicating a temperature of the PU 1106 relative to ambient temperature conditions), IR quantities, IR spectra, change rate (e.g., dT/dt quantities indicating changes to temperature (T) and/or other thermodynamic characteristics over time), and/or the like.

The SCM system 140 may be configured to monitor other SC 30 of the MD 20-1. For example, the SCM system 140 may comprise an SC DAQ module 240-PC configured to, inter alia, monitor a PC SC 30-PC of the MD 20-1. The SC 30-PC may correspond to power consumption of the MD 20-1 and/or specified component(s) thereof, such as PC of the PU 1106 and/or the like. The PC SCM data 130-PC acquired from the MD 20-1 may comprise and/or be derived from one or more factors including, but not limited to: current draw, current draw of the MD 20-1, current draw of the PU 1106, voltage potentials associated with such current draw, load on a PS 1110 of the MD 20-1, power flow to the PU 1106, and/or the like. The SC DAQ module 240-PC may comprise and/or be coupled to any suitable means for measuring PC characteristics including, but not limited to one or more current sensors, current transformers, voltage sensors, potentiometers, power meters, and/or the like.

The SCS module 120 may comprise and/or be coupled to a CSCA module 410. In the FIG. 11A example, the CSCA module 410 may be configured to characterize SC behavior of MD 20 of device type 25-1 configured in accordance with SWM 21-1. The CSCA module 410 may, therefore, be configured to characterize the behavior of SC 30 of MD 20-1. The CSCA module 410 may comprise an SCA modules 420 configured to characterize the behavior of respective SC 30 of the MD 20-1; the CSCA module 410 may comprise an SCA module 420-EM configured to characterize behavior of the SC 30-EM, an SCA module 420-TH configured to characterize behavior of the SC 30-TH, and an SCA module 420-PS configured to characterize behavior of the SC 30-PS.

The SCA modules 420 may be configured to generate SC health metrics 450 in response to the acquisition of SCM data 130 from the MD 20-1. The SC health metrics 450 may be configured to indicate a degree to which respective SC 30 of the MD 20-1 are indicative of nominal, non-anomalous operating conditions. Alternatively, or in addition, the SC health metrics 450 may be configured to indicate a degree to which SC behavior is indicative of anomalous operation and/or operation under specified anomaly types (e.g., specified types of threats, attacks, failures, and/or the like). For example, the SCA module 420-EM may be configured to generate SC health metrics 450-EM in response to the acquisition of SCM data 130-EM that characterize behavior of the SC 30-EM of the MD 20-1 (e.g., indicate a degree to which EM emissions of the SC 30-EM are indicative of nominal, non-anomalous operating conditions), the SCA module 420-TH may be configured to generate SC health metrics 450-TH in response to the acquisition of SCM data 130-TH that characterize behavior of the SC 30-TH of the MD 20-1 (e.g., indicate a degree to which TH behavior exhibited on SC 30-TH of the MD 20-1 is indicative of nominal, non-anomalous operating conditions), and the SCA module 420-PC may be configured to generate SC health metrics 450-PC in response to the acquisition of SCM data 130-PC that characterize behavior of the SC 30-PC of the MD 20-1 (e.g., indicate a degree to which PC characteristics of the MD 20-1 are indicative of nominal, non-anomalous operating conditions).

In some implementations, the SCA modules 420-EM, 420-TH, and/or 420-PS may be configured to compare observed SC behavior to one or more baselines, e.g., SC signatures 430 associated with known operating conditions (e.g., as described above in conjunction with FIG. 4). Alternatively, one or more of the SCA modules 420-EM, 420-TH, and/or 420-PS may comprise respective SCB models 620 configured to characterize the behavior exhibited by SC 30-EM, 30-TH, and/or 30-PS, respectively.

The CSCA module 410 may further comprise a CA module 440. The CA module 440 may be configured to generate health metrics 150 for the MD 20-1 based, at least in part, on the SC health metrics 450 determined for respective SC 30, e.g., based on SC health metrics 450-EM, 450-TH, and/or 450-PC. In some implementations, the health metrics 150 may be derived in accordance with CSCA logic 442. Alternatively, or in addition, aspects of the health metrics 150 may be generated by AI/ML components, such as an CSCD model 820.

The SCS module 120 may further comprise and/or be coupled to a mitigation module 160. As disclosed herein, the mitigation module 160 may be configured to determine and/or implement one or more mitigation actions 360A-M based, at least in part, on the health metrics 150 determined for the MD 20-1.

As disclosed herein, the SCS module 120 may be configured to detect threats and/or anomalies based on the behavior of SC pertaining to physical phenomena such as EM emission, thermal characteristics, power consumption, and so on. In some implementations, the SCS module 120 may be further configured to generate and/or analyze SC 30 pertaining to cyber and/or network behavior. As used herein, a network SC 30 may comprise and/or refer to a SC 30 pertaining to network communication activity pertaining to a MD 20. For example, a network SC 30 may correspond to side-channel packet features, such as packet size, payload size, as disclosed in further detail herein.

FIG. 11B is a schematic block diagram illustrating another example of an SCS module 120 configured to detect threats and/or anomalies pertaining to a MD 20-2. In the FIG. 11B example, the SCS module 120 may be configured to monitor an MD 20-2 of device type 25-2 configured to implement SWM 21-2. The MD 20-2 may comprise a network node 1112. As used herein, a network node 1112 may comprise and/or represent an entity (e.g., MD 20-2) configured to send, receive, and/or process data within a network 55 such as an intelligent electronic device (IED), communication module, communication controller, switch, router, Internet of Things (IoT) device, and/or the like. A network node 1112 may comprise and/or be implemented by hardware and/or software components. For example, the network node 1112 illustrated in FIG. 11B may comprise a network interface and network protocol stack, which may be configured to implement one or more network protocol suites or families per the Open Systems Interconnection (OSI) model.

The SCS module 120 may comprise and/or be coupled to a CSCA module 410, which may be configured to characterize SC behavior of MD 20 of device type 25-2 configured in accordance with SWM 21-2. Accordingly, the CSCA module 410 may be configured to characterize SC behavior of the MD 20-2. The CSCA module 410 may comprise an SCA module 420-EM configured to characterize the behavior of an EM SC 30-EM of the MD 20-2 and an SCA module 420-TH configured to characterize the behavior of a TH SC 30-TH of the MD 20-2.

As illustrated in the FIG. 11B example, the CSCA module 410 may further comprise an SCA module 420-NW configured to characterize the behavior exhibited by a NW SC 30-NW of the MD 20-2. The SCA module 420-NW may be configured to characterize NW behavior indicated by SCM data 130-NW. The SCM data 130-NW may be acquired by a SC DAQ module 240-NW. The SC DAQ module 240-NW may comprise and/or be coupled to any suitable means for monitoring network communication within a network 55 and/or network node 1112 including, but not limited to: data capture circuitry, data capture logic, communication circuitry, communication logic, communication processing circuitry, communication processing logic, communication capture circuitry, communication capture logic, communication filter circuitry, communication filter logic, sniffer circuitry, sniffer logic, a sniffer device, packet inspection circuitry, packet inspection logic, packet interpretation and/or analysis circuitry, packet interpretation and/or analysis logic, a network analyzer, and/or the like.

In some implementations, aspects the SC DAQ module 240-NW may be configured to monitor communication within the network 55. For example, the SC DAQ module 240-NW may comprise and/or be coupled to one or more NW sensor devices disposed within the network 55. Alternatively, or in addition, aspects of the SC DAQ module 240-NW may be coupled to the MD 20-2 and/or network node 1112. For example, aspects of the SC DAQ module 240-NW may be physically coupled to the network node 1112 (e.g., may be coupled to a diagnostic or monitoring port of the MD 20-2), may be coupled to software components of the network node 1112 (e.g., may be coupled to one or more media and/or host layers of the network node 209), and/or the like.

In some implementations, the SC DAQ module 240-NW may be configured to capture and/or analyze network communication (e.g., packet data) in real-time. For example, the SC DAQ module 240-NW may be configured to monitor communication between devices within the network 55. Alternatively, or in addition, the SC DAQ module 240-NW may be configured to monitor network communication at the MD 20-2 (e.g., at the network node 1112). For example, the SC DAQ module 240-NW may be configured to monitor incoming and outgoing communication that passes through the network node 1112 on a monitoring port such as a switch port analyzer (SPAN port) or the like. The SC DAQ module 240-NW may comprise and/or implement any suitable network monitoring and or analysis means. In some implementations, the SC DAQ module 240-NW may utilize one or more network capture and/or analysis tools, such as Scapy or the like.

In some implementations, the SC DAQ module 240-NW may be configured to capture and/or process raw network data, e.g., packets and/or other types of network communication data. The SC DAQ module 240-NW may be configured to capture, process, and/or analyze network communication data with respect and/or within respective NW SC windows. As used herein, a NW SC window may comprise and/or refer to a set of network communication data, e.g., a set or collection of packets. A NW SC window may comprise information pertaining to a particular number of packets e.g., windows comprising W_{P} packets where 1≤W_{P}≤W_{PMAX}, and W_{PMAX} is a maximum window size. Alternatively, the SC DAQ module 240-NW may be configured to capture and/or analyze network communication data corresponding to respective time windows, e.g., windows W_{T} comprising and/or corresponding to packets captured over respective time periods T.

The SC DAQ module 240-NW may be configured to maintain network communication data captured during respective windows within a queue or other data structure for subsequent, window-based processing. For example, the network communication data may be dissected to, inter alia, extract data pertaining to specified NW SC features. The NW SC features may pertain to any aspect of network communication including, but not limited to one or more of the NW SC features listed in Table 1 below:

TABLE 1

| NW SC Feature | Description |
|---|---|
| Packet_rate | Number of packets within a window |
| Protocol_type | Protocol(s) used in packet connection(s) |
| Flag | Status flags of respective connection(s) |
| Service | NW service destination(s) of respective packets |
| Num_src_IP | Number of different source IP addresses |
| Num_dst_IP | Number of different destination IP addresses |
| Num_src_port | Number of different source ports |
| Num_dst_port | Number of different destination ports |
| Min_data_length | The minimum data length of packets |
| Max_data_length | The maximum data length of packets |
| Avg_data_length | The average data length of packets |
| Ave_packet_size | Average size of the packets within the window |
| Ave_payload_size | Average payload size of packets within the window |
| Packet_size_ratio | Ratio packet sizes of adjacent packets within window |
| Min_win | The minimum window size of packets |
| Max_win | The maximum window size of packets |
| Avg_win | The average window size of packets |
| Min_time_intv | The minimum time gap between packets |
| Max_time_intv | The maximum time gap between packets |
| Avg_time_intv | The average time gap between packets |
| Min_pkt_src | The minimum number of packets per single source IP |
| Max_pkt_src | The maximum number of packets per single source IP |
| Avg_pkt_src | The average number of packets per single source IP |
| Min_pkt_dst | The minimum number of packets per single destination IP |
| Max_pkt_dst | The maximum number of packets per single destination IP |
| Min_ttl | The minimum time to live value of packets |
| Max_ttl | The maximum time to live value of packets |
| Avg_ttl | The average time to live value of packets |
| Num_byt | Number of bytes transmitted by packets |
| Same_src_dst | Number of packets with src IP = dst IP |
| Same_ports | Number of packets with src port = dst port |
| Same_src_src_port | Number of unique of src IP and src port combinations |
| Same_src_dst_port | Number of unique of src IP and dst port combinations |
| Same_dst_src_port | Number of unique of dst IP and src port combinations |
| Same_dst_dst_port | Number of unique of dst IP and dst port combinations |
| Same_IP_port | Number of packets with src IP = dst IP and src port == dst port |
| Num_urg | Number of urgent packets |
| Num_syn | Number of sync packets |
| Num_arp | Number of arp packets |

The NW SC features extracted and/or derived from respective windows by the SC DAQ module 240-NW comprise SCM data 130-NW, which may be included in the SCM data 250 acquired from the computing device (e.g., MD 20-2), as disclosed herein.

In some implementations, the SC DAQ module 240-NW may be configured to implement a partial packet inspection scheme. For example, the SC DAQ module 240-NW may be configured to operate on designated portions of respective packets (e.g., packet headers), which may reduce the overhead involved in capturing the SCM data 130-NW and/or enable the SC DAQ module 240-NW to monitor streams comprising large amounts of network communication data.

The SCA module 420-NW may be configured to generate SC health metrics 450-NW in response to the acquisition of SCM data 130-NW. the SC health metrics 450-NW may be configured to indicate a degree to which network behavior of the MD 20-2 is characteristic of “nominal” operating conditions. Alternatively, or in addition, the SC health metrics 450-NW may be configured to indicate a degree to which behavior exhibited by the SC 30-NW is indicative of “anomalous” operating conditions and/or a degree to which behavior of the SC 30-NW is indicative of specific types of anomalies. The SCA module 420-NW may be configured to compare observed behavior of the SC 30-NW to one or more baselines, e.g., SC signatures 430. Alternatively, or in addition, the SCA module 420-NW may comprise and/or be coupled to an AI/ML SCB model 620 trained to characterize SC behaviors indicated by SCM data 130-NW acquired by the SC DAQ module 240-NW.

In the FIG. 11B example, the CA module 440 may be configured to generate health metrics 150 for the MD 20-2 based, at least in part, on the SC health metrics 450-EM, 450-TH, and 450-NW generated for SC 30-EM, SC-TH, and SC-NW of the MD 20-2. The mitigation module 160 may be configured to determine and/or implement mitigation actions 360A-M based, at least in part, on the health metrics 150.

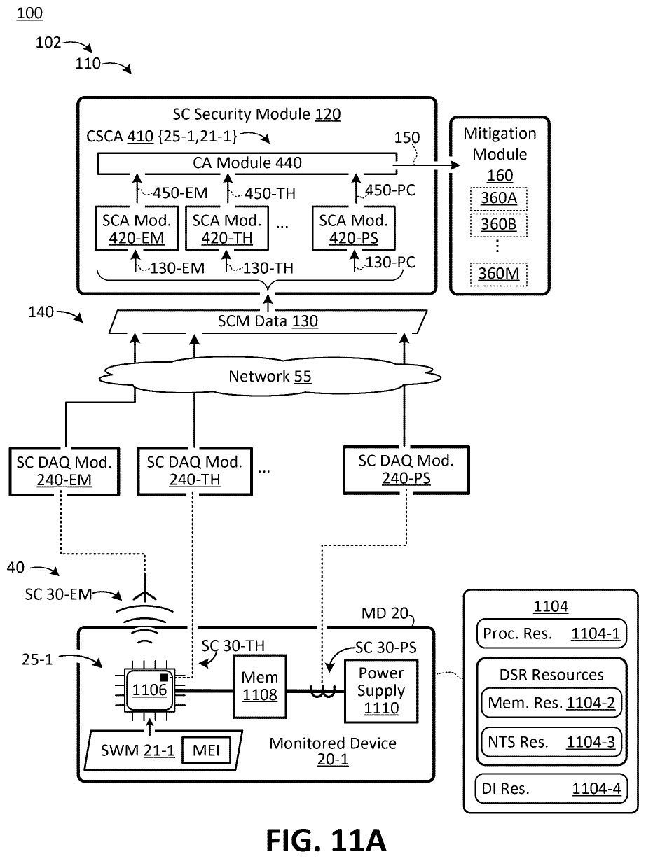

FIG. 12 is a schematic block diagram of another example of an SCS module 120 configured to detect threats and/or anomalies pertaining to an MD 20. In the FIG. 12 example, the SCS module 120 may be configured to monitor an MD 20-3. The MD 20-3 may comprise any suitable type of device including, but not limited to: a sensor device, an actuator device, a computing device, a control device, a controller, a computing device, and/or the like. The MD 20-3 may be of a specified deice type 25-3 and/or may be configured to implement a specified SWM 21-3.

The SCS module 120 may comprise and/or be coupled to a CSCA module 410, which may be configured to characterize SC behavior of MD 20 of device type 25-3 configured in accordance with SWM 21-3. Accordingly, the CSCA module 410 may be configured to characterize the SC behavior of MD 20-3.

In the FIG. 12 example, the CSCA module 410 may comprise and/or be coupled to an SCA module 420-EM configured to characterize the EM behavior exhibited by SC 30-EM of the MD 20-3. The SC 30-EM may correspond to EM emission of the MD 20-3 and/or one or more components thereof. In a first non-limiting example, the MD 20-3 may comprise a computing device and the SC 30-EM may correspond to EM emissions of a processor such as the PU 1106 illustrated in FIGS. 11A and 11B. In a second non-limiting example, the MD 20-3 may comprise a sensor device and the SC 30-EM may correspond to EM emissions of one or more sensor components of the MD 20-3. In a third non-limiting example, the MD 20-3 may comprise an actuator device and the SC 30-EM may correspond to EM emissions of an actuator of the MD 20-3 such as a motor, valve, solenoid, relay, and/or the like. Although particular types of SC 30-EM corresponding to particular components are described herein, the disclosure is not limited in this regard and could be adapted to monitor EM SC 30-EM corresponding to any suitable component(s) of any suitable MD 20.

The CSCA module 410 may be further configured to monitor a SC 30-TH of the MD 20-3. The SC 30-TH may correspond to thermal characteristics of any suitable component(s) of the MD 20-3. In a first non-limiting example, the MD 20-3 may comprise a computing device and the SC 30-TH may correspond to thermal characteristics of a processor and/or memory of the MD 20-3. In a second non-limiting example, the MD 20-3 may comprise a sensor device and the SC 30-TH may correspond to thermal characteristics of one or more sensor components. In a third non-limiting example, the MD 20-3 may comprise an actuator device and the SC 30-TH may correspond to thermal characteristics of one or more actuator components, e.g., may correspond to thermal characteristics of a motor, valve, solenoid, relay, and/or the like.

The SCS module 120 may comprise and/or be coupled to an SCM system 140. The SCM system 140 may comprise an SC DAQ module 240-EM configured to acquire SCM data 130-EM pertaining to the SC 30-EM of the MD 20-3 and an SC DAQ module 240-TH configured to acquire SCM data 130-TH pertaining to the SC 30-TH of the MD 20-3. The SC DAQ modules 240-EM and 240-TH may be configured to acquire SCM data 130-EM and 130-TH by any suitable means, as disclosed herein.

The CSCA module 410 may comprise an SCA module 420-EM, which may be configured to generate SC health metrics 450-EM in response to the acquisition of SCM data 130-EM pertaining to EM behavior of the SC 30-EM. The CSCA module 410 may further comprise an SCA module 450-TH, which may be configured to generate SC health metrics 450-TH in response to the acquisition of SCM data 130-TH pertaining to TH behavior of the SC 30-TH.

As illustrated in the FIG. 12 example, the SCA module 420-EM may comprise an SCB model 620-EM. The SCM model 620-EM may be trained to characterize EM emissions observed on the SC 30-EM. The SCM model 620-EM may be configured and/or implemented in accordance with a ML CFG 625-EM. The ML CFG 625-EM may be learned and/or refined through one or more AI/ML training procedures, as disclosed herein. The SCM model 620-EM may be configured to generate SC health metrics 450-EM in response to SCM data 130-EM. The SC health metrics 450-EM may be configured to indicate a degree to which EM emissions sensed on the SC 30-EM are characteristic of “nominal” operating conditions. Alternatively, or in addition, the SC health metrics 450-EM may be configured to indicate a degree to which the EM emissions sensed on the SC 30-EM are characteristic of “anomalous” operating conditions and/or particular anomaly types (e.g., may indicate a degree to which EM behavior is indicative of one or more of “Anomaly A” through “Anomaly F” of FIG. 5E).

As further illustrated in the FIG. 12 example, the SCA module 420-TH may comprise an SCB model 620-TH. The SCM model 620-TH may be trained to characterize behavior exhibited by the SC 30-TH. The SCM model 620-TH may be configured and/or implemented in accordance with a ML CFG 625-TH. The ML CFG 625-TH may be learned and/or refined through one or more AI/ML training procedures, as disclosed herein. The SCM model 620-TH may be configured to generate SC health metrics 450-TH in response to SCM data 130-TH. The SC health metrics 450-TH may be configured to indicate a degree to which TH characteristics exhibited by the SC 30-TH are characteristic of “nominal” operating conditions. Alternatively, or in addition, the SC health metrics 450-TH may be configured to indicate a degree to which the TH characteristics of the SC 30-TH are characteristic of “anomalous” operating conditions and/or particular anomaly types (e.g., may indicate a degree to which EM behavior is indicative of one or more of “Anomaly A” through “Anomaly F” of FIG. 5E).

The CSCA module 410 may further comprise and/or be coupled to a CA module 440. The CA module 440 may comprise a CSCD model 820. The CSCD model 820 may be implemented in accordance with an ML CFG 825. As disclosed herein, the ML CFG 825 may be adapted to configure the CSCD model 820 to accurately characterize the operating conditions of the MD 20-3 based on, inter alia, the behavior of a plurality of SC 30 of the MD 20-3. In the FIG. 12 example, the CSCD model 820 may be configured to generate health metrics 150 configured to characterize the operating conditions of the MD 20-3 based on behavior exhibited by SC 30-EM and 30-TH of the MD 20-3. More specifically, the CSCD model 820 may be configured to generate health metrics 150 for the MD 20-3 based, at least in part, on the SC health metrics 450-EM and 450-TH generated by SCM models 620-EM and 620-TH.

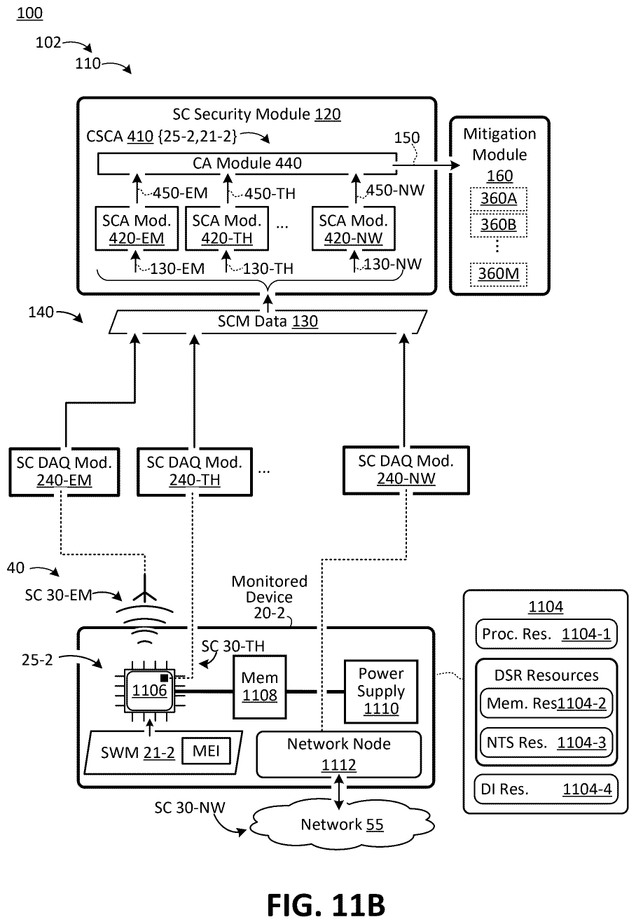

FIG. 13 is a schematic block diagram illustrating an example of an SCB model 620-EM configured to characterize the operating conditions of an MD 20 based, at least in part, on the behavior exhibited by an EM SC 30-EM. In other words, the SCB model 620-EM illustrated in FIG. 13 may be configured to generate SC health metrics 450-EM in response to SC data 130-EM, the EM SC health metrics 450-EM configured to quantify a degree to which to which the EM SCM data 130-EM is indicative of a threat or anomaly (and/or a degree to which the SCM data 252 is indicative of nominal, non-anomalous operating conditions).

The SCB model 620-EM may comprise any suitable AI/ML components. In the FIG. 13 example, the SCB model 620-EM may comprise a CNN, comprising a plurality of convolutional layers, fully connected layers, and dropout layers. More specifically, the SCB model 620-EM illustrated in the FIG. 13 example may comprise two two-dimensional convolutional layers followed by two fully connected layers (e.g., linear layers), followed by three dropout layers. The CNN of the SCB model 620-EM may utilize any suitable type of activation function; in the FIG. 13 example, the CNN may utilize leaky rectified linear units (e.g., Leaky ReLUs). In some implementations, the SCB model 620-EM may further comprise an input layer and/or output layer. The input layer may be configured to process SCM data 130-EM for input into the first convolutional layer and the output layer may be configured to generate and/or derive SC health metrics 450-EM from outputs of the last dropout layer (e.g., the third dropout layer). Alternatively, the first convolutional layer may be configured to process raw input data, e.g., SCM data 130-EM and the last dropout layer may be configured to generate SC health metrics 450-EM.

In some implementations, aspects of the EM SCB model 620-EM may be embodied by hardware components. Alternatively, or in addition, aspects of the EM SCB model 620-EM may be instantiated in software, e.g., within an AI/ML framework or the like. Table 2 comprises pseudo code configured to instantiate an EM SCB model 620-EM within an AM/ML framework such as pytorch or the like.

```
TABLE 2
class EM_CNN(nn.Module):
  def [symbol]   ᵢₙᵢₜ_{_{self}}
    super(EMCNN, self)._{——}init_{——}( )
    # one input channel, 64 output channels
    # instantiate convolutional layers
    self.conv1 = nn.Conv2d(1, 64, kernel_size = 3, stride = 1, padding =
    1)
    self.conv2 = nn.Conv2d(64, 128, kernel_size = 3, stride = 1,
    padding = 1)
    # instantiate linear, fully connected layers
    self.fc1 = nn.Linear(480000,200)
    self.fc2 = nn.Linear(200,3)
    # instantiate dropout layers
    self.dropout1 = nn.Dropout(0.25)
    self.dropout2 = nn.Dropout(0.5)
    self.dropout3 = nn.Dropout(0.5)
  def forward(self,x):
    x = self.conv1(x)
    x = F.relu(x)
    x = self.dropout1(x)
    x = self.conv2(x)
    x = F.relu(x)
    x = self.dropout2(x)
    x = F.max_pool2d(x,kernel_size = 2, stride = 2, padding=0)
    x = torch.flatten(x,1)
    x = self.fc1(x)
    x = F.relu(x)
    x = self.dropout3(x)
    x = self.fc2(x)
    output = F.log_softmax(x, dim=1)
    return x
```

As disclosed herein, the SCB model 620-EM may be configured in accordance with a machine-learned configuration, e.g., ML CFG 625-EM. The ML CFG 625-EM may define machine-learned hyperparameters, such as activation weights learned through AI/ML training procedures, as disclosed herein, e.g., through one or more AI/ML training iterations as described herein.

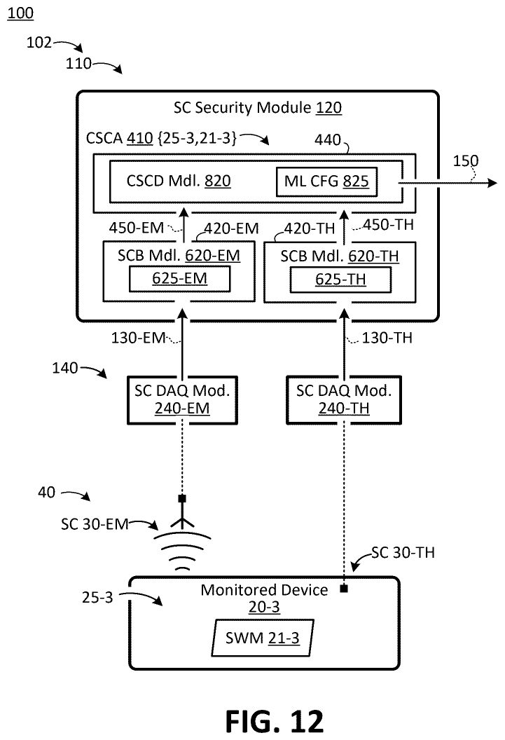

Although particular examples of SCB models 620 are described herein, the disclosure is not limited in this regard and could be adapted to incorporate SCB models 620 configured to detect threats and/or anomalies in response to SCM data 130 corresponding to any suitable SC 30. By way of further non-limiting example, FIG. 14 illustrates an example of an AI/ML SCB model 620-TH configured to detect threats and/or anomalies based on TH SC 30-TH, e.g., based on thermal SCM data 130-TH.

The SCB model 620-TH may be configured to process SCM data 130-TH and, in response, generate SC health metrics 450-TH configured to, inter alia, quantify a degree to which the SCM data 130-TH is indicative of a threat or anomaly (and/or a degree to which the SCM data 130-TH are indicative of nominal, non-anomalous operation).

The SCB model 620-TH may comprise any suitable AI/ML components. In the FIG. 14 example, the SCB model 620-TH comprises a feedforward ANN, comprising a plurality of fully connected layers. More specifically, the SCB model 620-TH may comprise three fully connected layers in a feedforward configuration. The SCB model 620-TH may utilize any suitable type of activation function and/or combination thereof. In some implementations, the SCB model 620-TH may further comprise an input layer and/or output layer. The input layer may be configured to process SCM data 130-TH for input into the first fully connected layer and the output layer may be configured to generate and/or derive SC health metrics 450-TH from outputs of the last fully connected (e.g., the third fully connected layer). Alternatively, the first fully connected layer may be configured to process raw input data, e.g., SCM data 130-TH and the last fully connected layer may be configured to generate SC health metrics 450-TH for the SC 30-TH.

In some implementations, aspects of the SCB model 620-TH may be embodied by hardware components. Alternatively, or in addition, aspects of the SCB model 620-TH may be instantiated in software, e.g., within an AI/ML framework or the like. Table 3 comprises pseudo code configured to instantiate a SCB model 620-TH within an AM/ML framework such as pytorch or the like.

TABLE 3

```
class TH_ANN(nn.Module):
  def [symbol]   ᵢₙᵢₜ _{_{self}}
    super(TH_ANN, self)._{——}init_{——}( )
    # 64 input channels, 2 output channels
    # instantiate fully connected layers
    self.fc1 = nn.Linear(64,128)
    self.fc2 = nn.Linear(128,256)
    self.fc3 = nn.Linear(256,2)
  def forward(self,x):
    x = x.reshape(−1,64)
    x = self.fc1(x)
    x = self.fc2(x)
    x = self.fc3(x)
    output = F.log_softmax(x, dim=1))
    return x
```

The SCB model 620-TH may be configured in accordance with a machine-learned configuration data, e.g., an ML CFG 625-TH. The ML CFG 625-TH may define machine-learned hyperparameters, such as activation weights learned through AI/ML training procedures, as disclosed herein, e.g., through one or more AI/ML training iterations as disclosed herein.

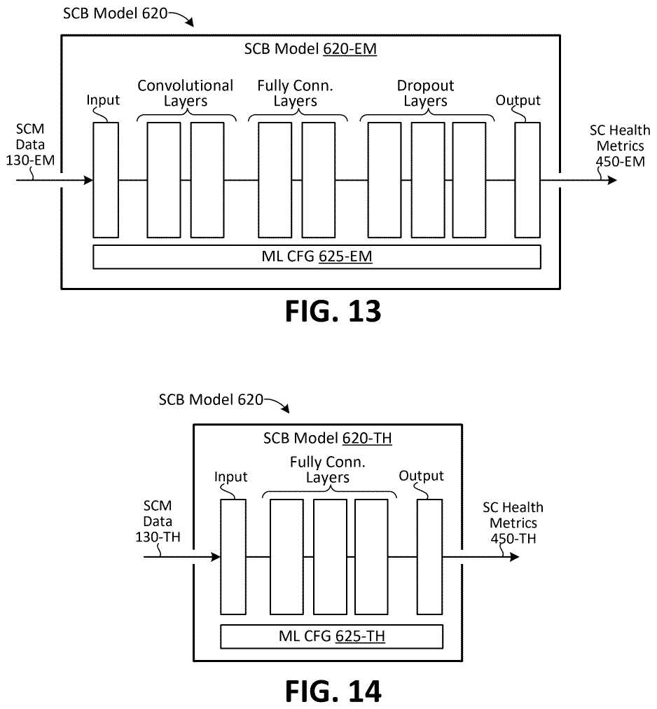

FIG. 15 is a schematic block diagram illustrating an example of a CSCA module 410 configured to characterize the operating conditions of an MD 20 of a device type 25 (and/or configured in accordance with a specified SWM 21) based on the behavior exhibited by an EM SC 30-EM and/or TH SC 30-TH of the MD 20. The CSCA module 410 may comprise an SCA module 420-EM, which may comprise an SCB model 620-EM configured in accordance with an ML CFG 625-EM, as illustrated in FIG. 13. The SCB model 620-EM may be configured to generate SC health metrics 450-EM in response to the acquisition of SCM data 130-EM from the EM SC 30-EM of the MD 20, as disclosed herein. The CSCA module 410 may further comprise an SCA module 420-TH, which may comprise an SCB model 620-TH configured in accordance with an ML CFG 625-TH, as illustrated in FIG. 14. The SCB model 620-TH may be configured to generate SC health metrics 450-TH in response to the acquisition of SCM data 130-TH from an TH SC 30-TH of the MD 20, as disclosed herein.

The CSCA module 410 may further comprise a CA module 440, which may be configured to generate health metrics 150 for the MD 20 based, at least in part, on the SC health metrics 450-EM and 450-TH generated by SCA modules 420-EM and 420-TH. In the FIG. 15 example, the CA module 440 comprises a CSCD model 820 configured in accordance with a ML CFG 825. The CSCD model 820 may comprise any suitable AI/ML components. On the FIG. 15 example, the CSCD model 820 comprises a three-layer feedforward ANN. The CSCD model 820 may be fed from outputs of the SCB models 620, e.g., may be fed from the SC health metrics 450-EM and 450-TH generated by SCB models 620-EM and 620-TH, respectively.

In some implementations, aspects of the CSCD model 820 may be embodied by hardware components. Alternatively, or in addition, aspects of the CSCD model 820 may be instantiated in software, e.g., within an AI/ML framework or the like. Table 4 comprises pseudo code configured to instantiate a CSCD model 820 within an AM/ML framework such as pytorch or the like.

TABLE 4

```
class CSCD_ANN(nn.Module):
  def [symbol]   ᵢₙᵢₜ _{_{self}}
    super(CSCD_ANN, self)._{——}init_{——}( )
    # 5 input channels, 3 output channels
    # instantiate fully connected layers
    self.fc1 = nn.Linear(5, 256)
    self.fc2 = nn.Linear(256,1024)
    self.fc3 = nn.Linear(1024,3)
  def forward(self,x):
    # x = concatenation of outputs of EM_CNN and TH_ANN
    x = x.reshape(−1,5)
    x = self.fc1(x)
    x = self.fc2(x)
    x = self.fc3(x)
    output = F.log_softmax(x, dim=1)
    return x
```

The CSCD model 820 illustrated in the FIG. 15 example may be configured in accordance with machine-learned configuration data, e.g., an ML CFG 825. The ML CFG 825 may define any suitable information pertaining to the CSCD model 820 such as machine-learned hyperparameters, e.g., activation weights learned through AI/ML training procedures, as disclosed herein. For example, aspects of the ML CFG 825 may be learned and/or refined through one or more AI/ML training iterations as disclosed herein.

In some implementations, the SCB models 620-EM and 620-TH may be independently trained (e.g., as disclosed herein in conjunction with FIG. 7A) and the CSCD model 820 may train the SCB models 620 to work together to achieve results that are more accurate than either would be capable of producing alone. In some implementations, the CSCD model 820 may be trained using previously trained SCB models 620 as illustrated in FIG. 9A. Alternatively, or in addition, the CSCD model 820 may be trained concurrently with one or more SCB models 620, e.g., as illustrated in FIG. 9B.

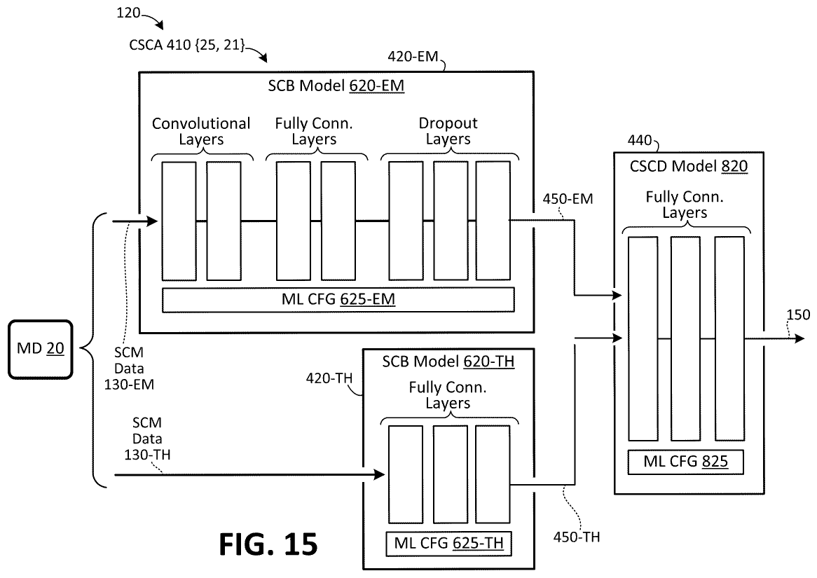

FIG. 16 is a flow diagram illustrating an example of a method 1600 for detecting anomalies pertaining to a MD 20 based on the behavior of SC 30 of the MD 20. Step 1610 may comprise assessing the behavior of a plurality of SC 30 of the MD 20. Step 1610 may comprise a) acquiring SCM data 130A-N pertaining to each of a plurality of SC 30A-N, and b) generating SC health metrics 450A-N based, at least in part, on the acquired SCM data 130A-N. At 1610, the SC health metrics 450A-N may be generated by respective SCA modules 420A-N, each configured to assess the behavior exhibited by a respective SC 30A-N. In some implementations, the SCA modules 420 may comprise AI/ML components, such as SCB models 620A-N, as disclosed herein. The SCB models 620A-N may be configured in accordance with ML CFG 625A-N. The ML CFG 625A-N may be learned and/or refined in respective AI/ML training operations, as disclosed herein. In some implementations, SCB models 620 for respective SC 30 may be trained independently, e.g., as illustrated in FIG. 7A. Alternatively, one or more SCB models 620 may be trained concurrently and/or in parallel as illustrated in FIG. 7B.

Step 1620 may comprise assessing the operating conditions of the MD 20 based, at least in part, on the assessments determined for the plurality of SC 30A-N. Step 1620 may comprise deriving health metrics 150 for the MD 20 from the SC health metrics 450A-N determined at 1610. In some implementations, the health metrics 150 may be derived by use of CSCA logic 442. For example, step 1620 may comprise combining, aggregating, and/or otherwise deriving health metrics 150 from a plurality of SC health metrics 450A-N.

Alternatively, or in addition, step 1620 may comprise generating health metrics 150 for the MD 20 by use of AI/ML components, such as an CSCD model 820. For example, the CSCD model 820 may comprise AI/ML components trained to accurately characterize the operating conditions of an MD 20 based on the behavior exhibited across a plurality of SC 30A-N. The CSCD model 820 may comprise a feedforward ANN as illustrated in FIG. 15. The CSCD model 820 may be configured in accordance with an ML CFG 825. The ML CFG 825 may be learned and/or refined in one or more AI/ML training operations. The ML CFG 825 may be developed using trained SCB models 620A-N, e.g., as illustrated in FIG. 9A. Alternatively, or in addition, the ML CFG 825 may be learned and/or refined concurrently with one or more SCB models 620A-N.

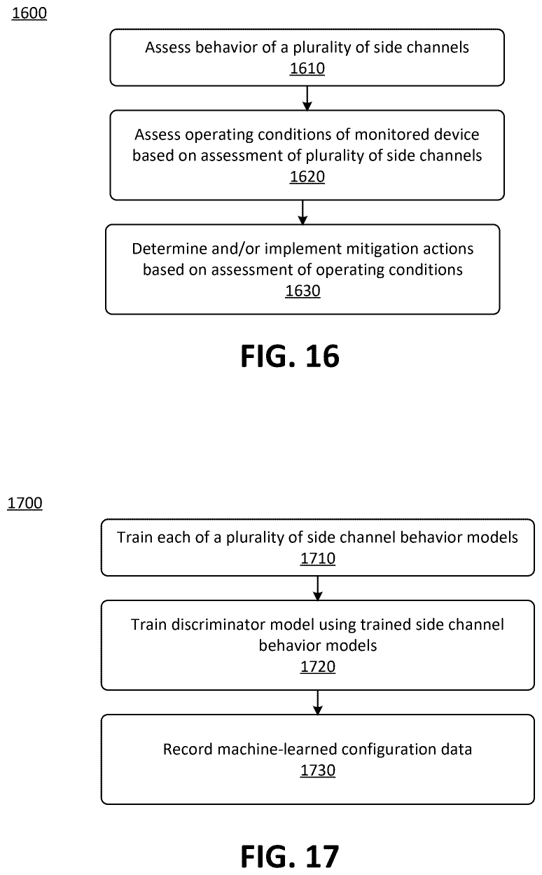

FIG. 17 is a flow diagram illustrating an example of a method 1700 for training a CSCA module 410 to detect threats and/or anomalies pertaining to MD 20 of a designated device type 25 and/or configured to implement a specified SWM 21.

Step 1710 may comprise training a plurality of SCB models 620 to accurately characterize the operating conditions of an MD 20 of the designated device type 25 and/or configured to implement the specified SWM 21 based on the behavior exhibited by a specified SC 30 of the MD 20. Step 1710 may comprise learning SCB models 620 for respective SC 30 separately and/or independently of other SC 30, as illustrated in FIG. 7A. Alternatively, or in addition, Step 1710 may comprise learning one or more SCB models 620 concurrently and/or in parallel as illustrated in FIG. 7B.

Step 1720 may comprise training a CSCD model 820 using, inter alia, one or more of the trained SCB models 620 developed at 1710. Step 1720 may comprise learning an ML CFG 825 for the CSCD model 820 as illustrated in FIGS. 9A and/or 9B.

Step 1730 may comprise recording machine-learned configuration data learned and/or refined during the implementation of steps 1710 and/or 1720. Step 1730 may comprise recording ML CFG 625 learned for one or more SCB models 620 at 1710. Step 1730 may further comprise recording ML CFG 825 learned for the CSCD model 820 at 1720.

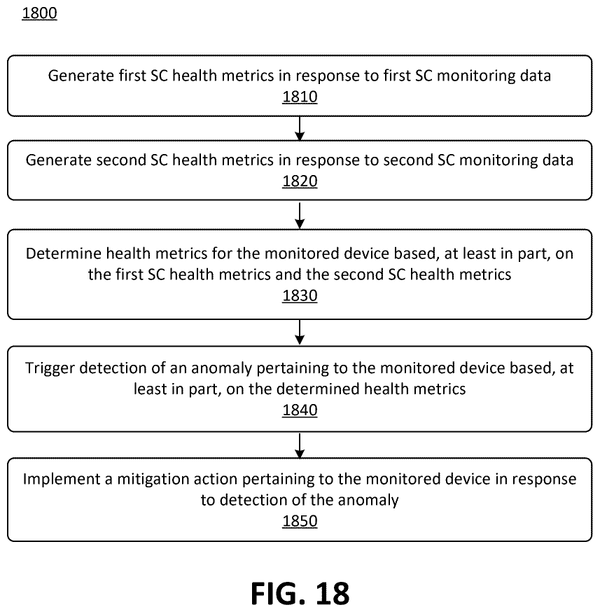

FIG. 18 is a flow diagram illustrating another example of a method 1800 for detecting anomalies pertaining to a monitored device based on the behavior of a plurality of side channels.

Step 1810 may comprise generating first SC health metrics 450A. The first SC health metrics 450A may be generated in response to first SC monitoring data 130A acquired from a first SC 30A of the MD 20. The first SC monitoring data 130A may be configured to characterize behavior of a first SC 30A of the MD 20. The first SC health metrics 450A may be generated by a first SCA module 420A and/or first SCB model 620A, as disclosed herein. The first SC monitoring data 130A may be acquired from the MD 20 by use of a first SC DAQ module 240A.

In some implementations, the first SC 30A may comprise an EM SC 30-EM and step 1810 may comprise acquiring EM SCM data 130-EM from the MD 20 by use of an EM SC DAQ module 240-EM. The disclosure is not limited in this regard, however, and could be adapted to monitor and/or determine first SC health metrics 450A corresponding to any suitable SC 30 of the MD 20.

By way of non-limiting example, the first SC health metrics 450A may be configured to quantify the degree to which the first SC monitoring data 130A corresponds to behavior of the first SC 30A indicative of nominal, non-anomalous behavior of the MD 20. Generating the first SC health metrics 450A may comprise comparing the first SCM data 130A acquired at 1810 to first SCS data 530. The first SCS data 530 may be configured to characterize behavior of the SC 30A during nominal, non-anomalous operation of the MD 20. Accordingly, deviation between the first SCM data 130A and the first SCS data 530 may be indicative of an anomaly pertaining to the MD 20. Alternatively, the first SCS data 530 may be configured to characterize behavior of the SC 30A during anomalous operation of the MD 20, e.g., may characterize behavior of the SC 30A under a threat, attack, failure, and/or other anomalous operating conditions. Correspondence between the first SCM data 130A and the first SCS data 530 may, therefore, be indicative of an anomaly (and/or deviation between the first SCM data 130A and the first SCS data 530 may be indicative of nominal, non-anomalous operation).

Alternatively, and by way of further non-limiting example, the first SC health metrics 450A may be generated by use of AI/ML components of the security module 110 at 1810. For example, step 1810 may comprise configuring a first ML SCB model 620A to generate the first SC health metrics 450A in response to the first SC monitoring data 130A acquired from the first SC 30A of the MD 20. The first ML SCB model 620A may be configured in accordance with a ML CFG 625A. The ML CFG 625A may be learned through one or more ML training procedures, as disclosed herein. The first ML SCB model 620A may comprise an EM SCB model 620-EM. For example, the first SCB model 620A may comprise an ANN as illustrated in FIGS. 13 and 15, e.g., may comprise a first ANN. The EM SCB model 620-EM may be configured to generate EM SC health metrics 450-EM in response to EM SCM data 130-EM. The disclosure is not limited in this regard, however, and could be adapted to utilize an ML SCB model 620 configured to characterize behavior of any suitable SC 30 of the MD 20.

Step 1820 may comprise generating second SC health metrics 450B. The second SC health metrics 450B may be generated in response to second SC monitoring data 130B acquired from a second SC 30B of the MD 20. The second SC monitoring data 130B may be configured to characterize behavior of a second SC 30B of the MD 20. The second SC health metrics 450B may be generated by a second SCA module 420B and/or second SCB model 620B, as disclosed herein. The second SC monitoring data 130B may be acquired from the MD 20 by use of a second SC DAQ module 240B.

In some implementations, the second SC 30B may comprise a TH SC 30-TH and step 1820 may comprise acquiring TH SCM data 130-TH from the MD 20 by use of a TH SC DAQ module 240-TH. Alternatively, the second SC 30B may comprise another type of SC 30. For example, the second SC 30B may comprise a NW SC 30-NW and step 1820 may comprise acquiring NW SCM data 130-NW from the MD 20 by use of a NW SC DAQ module 240-NW. The disclosure is not limited in this regard, however, and could be adapted to monitor and/or determine second SC health metrics 450B corresponding to any suitable SC 30 of the MD 20.

By way of non-limiting example, the second SC health metrics 450B may be configured to quantify the degree to which the second SC monitoring data 130B corresponds to behavior of the second SC 30B indicative of nominal, non-anomalous behavior of the MD 20. Generating the second SC health metrics 450B may comprise comparing the second SCM data 130B acquired at 1820 to second SCS data 530. The second SCS data 530 may be configured to characterize behavior of the SC 30B during nominal, non-anomalous operation of the MD 20. Accordingly, deviation between the second SCM data 130B and the second SCS data 530 may be indicative of an anomaly pertaining to the MD 20. Alternatively, the second SCS data 530 may be configured to characterize behavior of the SC 30B during anomalous operation of the MD 20, e.g., may characterize behavior of the SC 30B under a threat, attack, failure, and/or other anomalous operating conditions. Correspondence between the second SCM data 130B and the second SCS data 530 may, therefore, be indicative of an anomaly (and/or deviation between the second SCM data 130B and the second SCS data 530 may be indicative of nominal, non-anomalous operation).

Alternatively, and by way of further non-limiting example, the second SC health metrics 450B may be generated by use of AI/ML components of the security module 110 at 1820. For example, step 1820 may comprise configuring a second ML SCB model 620B to generate the second SC health metrics 450B in response to the second SC monitoring data 130B acquired from the second SC 30B of the MD 20. The second ML SCB model 620B may be configured in accordance with a ML CFG 625B. The ML CFG 625B may be learned through one or more ML training procedures, as disclosed herein. The second ML SCB model 620B may comprise a TH SCB model 620-TH. For example, the second SCB model 620B may comprise an ANN as illustrated in FIGS. 14 and 15, e.g., may comprise a second ANN. The TH SCB model 620-TH may be configured to generate TH SC health metrics 450-TH in response to TH SCM data 130-TH. The disclosure is not limited in this regard, however, and could be adapted to utilize an ML SCB model 620 configured to characterize behavior of any suitable SC 30 of the MD 20.

Step 1830 may comprise determining health metrics 150 for the MD 20 based, at least in part on the first SC health metrics 450A generated at 1810 and the second SC health metrics 450B generated at 1820. Step 1830 may comprise combining the first SC health metrics 450A and second SC health metrics 450B, e.g., may comprise aggregating, averaging, weighted averaging, and/or the like.

Alternatively, and by way of further example, determining the health metrics 150 at 1830 may comprise configuring an ML CSCD model 820 to determine the health metrics 150 for the MD 20 in response to the first SC health metrics 450A generated at 1810 and the second SC health metrics 450B generated at 1820. The CSCD model 820 may be configured in accordance with a ML CFG 825. The ML CFG 825 may be learned in one or more ML training procedures, as disclosed herein. In some implementations, the CSCD model 820 may comprise an ANN as illustrated in FIG. 15, e.g., may comprise a third ANN.

Step 1840 may comprise triggering detection of an anomaly pertaining to the MD 20 based, at least in part, on the determined health metrics 150. The health metrics 150 may be determined by use of a CSCD model 820, as disclosed herein.

In some implementations, the first SC metrics 450A may be configured to quantify deviation between the first SC monitoring data 130A and a first SC signature 530A configured to characterize behavior of the first SC 30A during nominal, non-anomalous operation of the MD 20 and the second SC metrics 450B may be configured to quantify deviation between the second SC monitoring data 130B and a second SC signature 530B configured to characterize behavior of the second SC 30B during nominal, non-anomalous operation of the MD 20. At 1840, detection of an anomaly may be triggered in response to one or more of (a) the first SC health metrics 450A generated at 1810 exceeding a first threshold (b) the second SC health metrics 450B generated at 1820 exceeding a second threshold, and/or the (c) the health metrics 150 determined at 1830 exceeding a third threshold. The first, second, and/or third thresholds may be determined in accordance with testing and experience. For example, the first threshold may indicate a difference between the first SC monitoring data 130A and “nominal” SC signature data 530 indicative of anomalous operation of the MD 20 (based on behavior exhibited by the first SC 30A); the second threshold may indicate a difference between the second SC monitoring data 130B and “nominal” SC signature data 530 indicative of anomalous operation of the MD 20 (based on behavior exhibited by the second SC 30B); and the third threshold may indicate a deviation quantified by the health metrics 150 indicative of anomalous operation of the MD 20 (based on a combination of the behaviors exhibited by the first and second SC 30A and 30B).

Alternatively, or in addition, in some implementations (a) the first SC health metrics 450A may be generated by a first SCB model 620A, (b) the second SC health metrics 450B may be generated by a second SCM model 620B, and (c) the health metrics 150 may be generated by a CSCD model 820, e.g., as illustrated in FIGS. 13-15. The first SC health metrics 450A may indicate a degree to which the first SCM data 130A are indicative of an anomaly, e.g., per the first SCB model 620A; the second SC health metrics 450B may indicate a degree to which the second SCM data 130B are indicative of an anomaly, e.g., per the second SCB model 620B; and the health metrics 150 may indicate a degree to which a combination of the first SC health metrics 450A and the second SC health metrics 450B are indicative of an anomaly, e.g., per the CSCD model 820.

Step 1850 may comprise implementing a mitigation action 360 pertaining to the MD 20 in response to detection of the anomaly at 1840. At 1850, the mitigation module 160 may be configured to implement any suitable mitigation action(s) 360 including, but not limited to: notifying one or more external entities of the detected threat or anomaly, such as a user, administrator, security system, intrusion detection system, or the like (e.g., sending electronic message(s), email, text message(s), and/or the like), configuring the MD 20 to operate in a specified mode (e.g., configure the MD 20 to operate in a “safe” mode), resetting the MD 20 (e.g., resetting the SWM 21 implemented by the MD 20), disabling the MD 20, reconfiguring the MS 40 (e.g., replacing the MD 20 with other components of the MS 40), and/or the like. The mitigation module 160 may be configured to implement any number of mitigation actions 360 in response to health metrics 150 indicating detection of threats and/or anomalies. For example, the mitigation module 160 may be configured to implement M mitigation actions 360A-M in response to detecting a threat and/or anomaly pertaining to the MD 20, as illustrated in FIG. 3.

### CONCLUSION

This disclosure has been made with reference to various example embodiments. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general-purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the claims.

We claim:

1. A system for detecting anomalies pertaining to a monitored device based, at least in part, on behavior exhibited by one or more side channels of the monitored device, the system comprising:
a processor;
a side channel (SC) security module configured for operation on the processor, wherein the SC security module comprises:
a first SC analysis module configured to generate first SC health metrics in response to first SC monitoring data configured to characterize behavior of a first SC of the monitored device,
a second SC analysis module configured to generate second SC health metrics in response to second SC monitoring data configured to characterize behavior of a second SC of the monitored device, the second SC different to the first SC, and
a combined assessment module configured to trigger detection of an anomaly pertaining to the monitored device based, at least in part, on the first SC health metrics generated from the first SC monitoring data and the second SC health metrics generated from the second SC monitoring data; and
a mitigation module configured to implement a mitigation action pertaining to the monitored device in response to detection of the anomaly.

2. The system of claim 1, further comprising:
a first SC data acquisition module configured to acquire the first SC monitoring data from an electromagnetic radiation (EM) SC of the monitored device such that the first SC monitoring data characterizes the behavior of the EM SC of the monitored device; and
a second SC data acquisition module configured to acquire the second SC monitoring data from one of:
a thermal (TH) SC of the monitored device such that the second SC monitoring data characterizes the behavior of the TH SC of the monitored device, and
a network (NW) SC of the monitored device such that the second SC monitoring data characterizes the behavior of the NW SC of the monitored device.

3. The system of claim 1, wherein:
the first SC health metrics are configured to quantify a degree to which the behavior of the first SC characterized by the first SC monitoring data correspond to first SC signature data, the first SC signature data configured to characterize behavior of the first SC during nominal, non-anomalous operation of the monitored device; and
the second SC health metrics are configured to quantify a degree to which the behavior of the second SC characterized by the second SC monitoring data correspond to second SC signature data, the second SC signature data configured to characterize behavior of the second SC during nominal, non-anomalous operation of the monitored device.

4. The system of claim 3, wherein the combined assessment module is configured to trigger detection of an anomaly pertaining to the monitored device in response to one or more of:
determining that a first deviation between the first SC monitoring data and the first SC signature data exceeds a first threshold;
determining that a second deviation between the second SC monitoring data and the second SC signature data exceeds a second threshold; and
determining that a combination of the first deviation and the second deviation exceeds a third threshold.

5. The system of claim 1, wherein the first SC analysis module is configured to generate the first SC health metrics based, at least in part, on a comparison between the first SC monitoring data and first SC signature data, and wherein the first SC signature data are configured to characterize behavior of the first SC of the monitored device under one or more of:
nominal, non-anomalous operating conditions of the monitored device;
anomalous operating conditions of the monitored device; and
anomalous operating conditions of the monitored device corresponding to a specified type of anomaly.

6. The system of claim 5, wherein the first SC signature data are configured to characterize the behavior of the first SC during execution of a specified software module on the monitored device.

7. The system of claim 6, wherein the SC security module is further configured to retrieve the first SC signature data from a SC behavior profile selected from a plurality of SC behavior profiles maintained within a non-transitory storage medium, and wherein the SC security module is configured to select the SC behavior profile based on one or more of a device type of the monitored device and the specified software module executing on the monitored device.

8. The system of claim 1, wherein:
the first SC analysis module comprises a first machine-learned (ML) SC behavior model configured to generate the first SC health metrics in response to the first SC monitoring data acquired from the first SC of the monitored device;
the second SC analysis module comprises a second ML SC behavior model configured to generate the second SC health metrics in response to the second SC monitoring data acquired from the second SC of the monitored device;
the combined assessment module comprises a ML complimentary SC discriminator model configured to generate health metrics for the monitored device in response to the first SC health metrics generated by the first ML SC behavior model and the second SC health metrics generated by the second ML SC behavior model; and
the security module is configured to trigger detection of an anomaly pertaining to the monitored device based, at least in part, on the health metrics generated by the ML complementary SC discriminator model.

9. The system of claim 8, wherein the first SC comprises an EM SC of the monitored device, and wherein the first ML SC behavior model comprises a first artificial neural network (ANN), comprising:
one or more convolutional layers configured to produce first output data in response to the first SC monitoring data;
one or more fully connected layers configured to produce a second output data in response to the first output data produced by the one or more convolutional layers; and
one or more dropout layers configured to produce third output data in response to the second output data generated by the one or more fully connected layers; and
wherein the first SC metric is based, at least in part, on the third output data produced by the one or more dropout layers.

10. The system of claim 9, wherein the second SC comprises a TH SC of the monitored device, and wherein the second ML SC behavior model comprises a second ANN, the second ANN comprising one or more fully connected layers configured to produce output data in response to the second SC monitoring data, wherein the second SC metric is based, at least in part, on the output data produced by the one or more fully connected layers.

11. A method for detecting anomalies pertaining to a monitored device based, at least in part, on behavior exhibited by one or more side channels of the monitored device, the method comprising:
generating first SC health metrics in response to first SC monitoring data, the first SC monitoring data configured to characterize behavior of a first SC of the monitored device;
generating second SC health metrics in response to second SC monitoring data, the second SC monitoring data configured to characterize behavior of a second SC of the monitored device different to the first SC;
determining health metrics for the monitored device based, at least in part, on the first SC health metrics generated from the first SC monitoring data and the second SC health metrics generated from the second SC monitoring data;
triggering detection of an anomaly pertaining to the monitored device based, at least in part, on the determined health metrics; and
implementing a mitigation action pertaining to the monitored device in response to detection of the anomaly.

12. The method of claim 11, further comprising:
acquiring the first SC monitoring data from an electromagnetic radiation (EM) SC of the monitored device such that the first SC monitoring data characterizes the behavior of the EM SC of the monitored device; and
acquiring the second SC monitoring data from one of:
a thermal (TH) SC of the monitored device such that the second SC monitoring data characterizes the behavior of the TH SC of the monitored device, and
a network (NW) SC of the monitored device such that the second SC monitoring data characterizes the behavior of the NW SC of the monitored device.

13. The method of claim 11, wherein:
the first SC health metrics are configured to quantify a degree to which the behavior of the first SC characterized by the first SC monitoring data correspond to first SC signature data, the first SC signature data configured to characterize behavior of the first SC during nominal, non-anomalous operation of the monitored device;
the second SC health metrics are configured to quantify a degree to which the behavior of the second SC characterized by the second SC monitoring data correspond to second SC signature data, the second SC signature data configured to characterize behavior of the second SC during nominal, non-anomalous operation of the monitored device; and
detection of the anomaly pertaining to the monitored device is triggered in response to one or more of:
determining that a first deviation between the first SC monitoring data and the first SC signature data exceeds a first threshold,
determining that a second deviation between the second SC monitoring data and the second SC signature data exceeds a second threshold, and
determining that a combination of the first deviation and the second deviation exceeds a third threshold.

14. The method of claim 11, wherein the first SC health metrics are generated based, at least in part, on a comparison between the first SC monitoring data and first SC signature data, and wherein the first SC signature data are configured to characterize behavior of the first SC of the monitored device under one or more of:
nominal, non-anomalous operating conditions of the monitored device;
anomalous operating conditions of the monitored device; and
anomalous operating conditions of the monitored device corresponding to a specified type of anomaly.

15. The method of claim 14, wherein the first SC signature data are configured to characterize the behavior of the first SC during execution of a specified software module on the monitored device, the method further comprising:
retrieving the first SC signature data from a SC behavior profile, the retrieving comprising selecting the SC behavior profile from a plurality of SC behavior profiles maintained within a non-transitory storage medium based on one or more of a device type of the monitored device and the specified software module executing on the monitored device.

16. The method of claim 11, further comprising:
configuring a first machine-learned (ML) SC behavior model to generate the first SC health metrics in response to the first SC monitoring data acquired from the first SC of the monitored device;
configuring a second ML SC behavior model to generate the second SC health metrics in response to the second SC monitoring data acquired from the second SC of the monitored device;
configuring a ML complimentary SC discriminator model to determine the health metrics for the monitored device in response to the first SC health metrics generated by the first ML SC behavior model and the second SC health metrics generated by the second ML SC behavior model; and
triggering detection of the anomaly pertaining to the monitored device based, at least in part, on the health metrics determined by the ML complementary SC discriminator model.

17. The method of claim 16, wherein the first SC comprises an EM SC of the monitored device, and wherein the first ML SC behavior model comprises a first artificial neural network (ANN), comprising:
one or more convolutional layers configured to produce first output data in response to the first SC monitoring data;
one or more fully connected layers configured to produce a second output data in response to the first output data produced by the one or more convolutional layers; and
one or more dropout layers configured to produce third output data in response to the second output data generated by the one or more fully connected layers; and
wherein the first SC metric is based, at least in part, on the third output data produced by the one or more dropout layers of the first ML SC behavior model.

18. The method of claim 17, wherein the second SC comprises a TH SC of the monitored device, and wherein the second ML SC behavior model comprises a second ANN, the second ANN comprising one or more fully connected layers configured to produce output data in response to the second SC monitoring data, wherein the second SC metric is based, at least in part, on the output data produced by the one or more fully connected layers of the second ML SC behavior model.

19. The method of claim 18, wherein the ML complimentary SC discriminatory model comprises a third ANN, the third ANN comprising one or more fully connected layers configured to generate the health metrics for the monitored device in response to the first SC health metrics generated by the first ANN and the second SC health metrics generated by the second ANN.

20. The method of claim 16, further comprising:
training the first ML SC behavior model to generate the first SC health metrics in response to the first SC monitoring data by use of a first SC training dataset comprising first SC data characteristic of known behaviors of the first SC of the monitored device;
training the second ML SC behavior model to generate the second SC health metrics in response to the second SC monitoring data by use of a second SC training dataset comprising second SC data characteristic of known behaviors of the second SC of the monitored device; and
training the complimentary SC discriminator model to generate health metrics for the monitored device in response to the first SC health metrics and the second SC health metrics generated by the first ML SC behavior model and the second ML SC behavior model in response to the first SC training dataset and the second SC training dataset.

21. A non-transitory storage medium comprising instructions configured for execution by a processor of a computing device, the instructions configured to cause the computing device to implement operations for detecting anomalies pertaining to a monitored device based, at least in part, on behavior exhibited by one or more side channels of the monitored device, the operations comprising:
generating first SC health metrics in response to first SC monitoring data, the first SC monitoring data configured to characterize behavior of an electromagnetic radiation (EM) SC of the monitored device;
generating second SC health metrics in response to second SC monitoring data, the second SC monitoring data configured to characterize behavior of a thermal (TH) SC of the monitored device;
determining health metrics for the monitored device based, at least in part, on the first SC health metrics and the second SC health metrics;
triggering detection of an anomaly pertaining to the monitored device based, at least in part, on the determined health metrics; and
implementing a mitigation action pertaining to the monitored device in response to detection of the anomaly.

22. The non-transitory computer-readable storage medium of claim 21, wherein:
the first SC health metrics are generated based, at least in part, on a comparison between the first SC monitoring data and first SC signature data, and wherein the first SC signature data are configured to characterize behavior of the first SC of the monitored device under one or more of:
nominal, non-anomalous operating conditions of the monitored device,
anomalous operating conditions of the monitored device, and
anomalous operating conditions of the monitored device corresponding to a specified type of anomaly,
the first SC signature data are configured to characterize the behavior of the EM SC during execution of a specified software module on the monitored device, the operations further comprising:
retrieving the first SC signature data from a SC behavior profile, the retrieving comprising selecting the SC behavior profile from a plurality of SC behavior profiles maintained within a non-transitory storage medium based on one or more of a device type of the monitored device and the specified software module executing on the monitored device.

23. The non-transitory computer-readable storage medium of claim 21, the operations further comprising:
configuring a first machine-learned (ML) SC behavior model to generate the first SC health metrics in response to the first SC monitoring data acquired from the EM SC of the monitored device;
configuring a second ML SC behavior model to generate the second SC health metrics in response to the second SC monitoring data acquired from the TH SC of the monitored device;
configuring a ML complimentary SC discriminator model to determine the health metrics for the monitored device in response to the first SC health metrics generated by the first ML SC behavior model and the second SC health metrics generated by the second ML SC behavior model; and
triggering detection of the anomaly pertaining to the monitored device based, at least in part, on the health metrics determined by the ML complementary SC discriminator model.

24. The non-transitory computer-readable storage medium of claim 23, wherein:
the first ML SC behavior model comprises a first artificial neural network (ANN), the first ANN comprising:
one or more convolutional layers configured to produce first output data in response to the first SC monitoring data,
one or more fully connected layers configured to produce a second output data in response to the first output data produced by the one or more convolutional layers, and
one or more dropout layers configured to produce third output data in response to the second output data generated by the one or more fully connected layers, wherein the first SC metrics are based, at least in part, on the third output data produced by the one or more dropout layers of the first ML SC behavior model;
the second ML SC behavior model comprises a second ANN, the second ANN comprising one or more fully connected layers configured to produce output data in response to the second SC monitoring data, wherein the second SC metric is based, at least in part, on the output data produced by the one or more fully connected layers of the second ML SC behavior model; and
the ML complimentary SC discriminatory model comprises a third ANN, the third ANN comprising one or more fully connected layers configured to generate the health metrics for the monitored device in response to the first SC health metrics generated by the first ANN and the second SC health metrics generated by the second ANN.

25. The non-transitory computer-readable storage medium of claim 24, further comprising:
training the first ML SC behavior model to generate the first SC health metrics in response to the first SC monitoring data by use of a first SC training dataset comprising first SC data characteristic of known behaviors of the first SC of the monitored device;
training the second ML SC behavior model to generate the second SC health metrics in response to the second SC monitoring data by use of a second SC training dataset comprising second SC data characteristic of known behaviors of the second SC of the monitored device; and
training the complimentary SC discriminator model to generate health metrics for the monitored device in response to the first SC health metrics and the second SC health metrics generated by the first ML SC behavior model and the second ML SC behavior model in response to the first SC training dataset and the second SC training dataset.
